(19) United States
(12) Patent Application Publication
(10) Pub. No.: US 2024/0428241 A1
(43) Pub. Date: Dec. 26, 2024

(54) PROVING AND VERIFYING AN ORDERED SEQUENCE OF EVENTS

(71) Applicant: nChain Licensing AG, Zug (CH)

(72) Inventors: Owen VAUGHAN, London (GB); Mehmet Sabir KIRAZ, London (GB)

(21) Appl. No.: 18/728,036

(22) PCT Filed: Jan. 12, 2023
(86) PCT No.: PCT/EP2023/050653

§ 371 Date: Jul. 10, 2024

(30) Foreign Application Priority Data
Jan. 13, 2022 (GB) 2200400.6

(51) Int. Cl. G06Q 20/38; G06Q 20/12

(52) U.S. Cl. CPC G06Q 20/389; G06Q 20/1235

(57) ABSTRACT

A computer implemented method of providing proof of an ordered sequence of events, the method performed on a computing device and comprising: receiving a transaction; creating a further transaction to be sent to a further computing device; obtaining proof data associated with the further transaction that provides proof to the further computing device that the further transaction is linked to an initial transaction in a transaction chain comprising the transaction, wherein the initial transaction relates to an initial event in the ordered sequence of events, and the proof data comprises: (i) a proof; (ii) an identifier of the transaction; and (iii) a unique identifier of the initial transaction; and sending the further transaction and the proof data to the further computing device.

### CROSS REFERENCE TO RELATED APPLICATIONS

This application is the U.S. National Stage of International Application No. PCT/EP2023/050653 filed on Jan. 12, 2023, which claims the benefit of United Kingdom Patent Application No. 2200400.6, filed on Jan. 13, 2022, the contents of which are incorporated herein by reference in their entireties.

### TECHNICAL FIELD

The present disclosure relates to providing proof of an ordered sequence of events, and verifying an ordered sequence of events.

### BACKGROUND

A blockchain refers to a form of distributed data structure, wherein a duplicate copy of the blockchain is maintained at each of a plurality of nodes in a distributed peer-to-peer (P2P) network (referred to below as a “blockchain network”) and widely publicised. The blockchain comprises a chain of blocks of data, wherein each block comprises one or more transactions. Each transaction, other than so-called “coinbase transactions”, points back to a preceding transaction in a sequence which may span one or more blocks going back to one or more coinbase transactions. Coinbase transactions are discussed further below. Transactions that are submitted to the blockchain network are included in new blocks. New blocks are created by a process often referred to as “mining”, which involves each of a plurality of the nodes competing to perform “proof-of-work”, i.e. solving a cryptographic puzzle based on a representation of a defined set of ordered and validated pending transactions waiting to be included in a new block of the blockchain. It should be noted that the blockchain may be pruned at some nodes, and the publication of blocks can be achieved through the publication of mere block headers.

The transactions in the blockchain may be used for one or more of the following purposes: to convey a digital asset (i.e. a number of digital tokens), to order a set of entries in a virtualised ledger or registry, to receive and process timestamp entries, and/or to time-order index pointers. A blockchain can also be exploited in order to layer additional functionality on top of the blockchain. For example blockchain protocols may allow for storage of additional user data or indexes to data in a transaction. There is no pre-specified limit to the maximum data capacity that can be stored within a single transaction, and therefore increasingly more complex data can be incorporated. For instance this may be used to store an electronic document in the blockchain, or audio or video data.

Nodes of the blockchain network (which are often referred to as “miners”) perform a distributed transaction registration and verification process, which will be described in more detail later. In summary, during this process a node validates transactions and inserts them into a block template for which they attempt to identify a valid proof-of-work solution. Once a valid solution is found, a new block is propagated to other nodes of the network, thus enabling each node to record the new block on the blockchain. In order to have a transaction recorded in the blockchain, a user (e.g. a blockchain client application) sends the transaction to one of the nodes of the network to be propagated.

Nodes which receive the transaction may race to find a proof-of-work solution incorporating the validated transaction into a new block. Each node is configured to enforce the same node protocol, which will include one or more conditions for a transaction to be valid. Invalid transactions will not be propagated nor incorporated into blocks. Assuming the transaction is validated and thereby accepted onto the blockchain, then the transaction (including any user data) will thus remain registered and indexed at each of the nodes in the blockchain network as an immutable public record.

The node who successfully solved the proof-of-work puzzle to create the latest block is typically rewarded with a new transaction called the “coinbase transaction” which distributes an amount of the digital asset, i.e. a number of tokens. The detection and rejection of invalid transactions is enforced by the actions of competing nodes who act as agents of the network and are incentivised to report and block malfeasance. The widespread publication of information allows users to continuously audit the performance of nodes. The publication of the mere block headers allows participants to ensure the ongoing integrity of the blockchain.

In an “output-based” model (sometimes referred to as a UTXO-based model), the data structure of a given transaction comprises one or more inputs and one or more outputs. Any spendable output comprises an element specifying an amount of the digital asset that is derivable from the proceeding sequence of transactions. The spendable output is sometimes referred to as a UTXO (“unspent transaction output”). The output may further comprise a locking script specifying a condition for the future redemption of the output. A locking script is a predicate defining the conditions necessary to validate and transfer digital tokens or assets. Each input of a transaction (other than a coinbase transaction) comprises a pointer (i.e. a reference) to such an output in a preceding transaction, and may further comprise an unlocking script for unlocking the locking script of the pointed-to output. So consider a pair of transactions, call them a first and a second transaction (or “target” transaction). The first transaction comprises at least one output specifying an amount of the digital asset, and comprising a locking script defining one or more conditions of unlocking the output. The second, target transaction comprises at least one input, comprising a pointer to the output of the first transaction, and an unlocking script for unlocking the output of the first transaction.

In such a model, when the second, target transaction is sent to the blockchain network to be propagated and recorded in the blockchain, one of the criteria for validity applied at each node will be that the unlocking script meets all of the one or more conditions defined in the locking script of the first transaction. Another will be that the output of the first transaction has not already been redeemed by another, earlier valid transaction. Any node that finds the target transaction invalid according to any of these conditions will not propagate it (as a valid transaction, but possibly to register an invalid transaction) nor include it in a new block to be recorded in the blockchain.

An alternative type of transaction model is an account-based model. In this case each transaction does not define the amount to be transferred by referring back to the UTXO of a preceding transaction in a sequence of past transactions, but rather by reference to an absolute account balance. The current state of all accounts is stored by the nodes separate to the blockchain and is updated constantly.

Bitcoin allows data to be inserted into transactions and stored immutably on the blockchain. A concise proof of transaction integrity is given by a process known as Simplified Payment Verification. However, additional information can also be conveyed by the relationships between transactions. For instance, if transaction B spends one of the outputs of transaction A, then by the rules of the protocol we know that transaction B was created after transaction A.

The concept of transaction ordering can be extended to linear transactions chains. If each transaction spends the output of a previous transaction in the chain, then an immutable ordering can be established. This ordering is inherited by data payloads within the transactions, and it is supported by proof-of-work.

At present, there is no concise way to prove that two transactions are linked through a transaction chain without using a trusted third party. Instead, one must identify all transactions in the chain and explicitly check that each transaction spends an output of the previous transaction. Although this may be an efficient method for many use cases, the storage cost grows linearly with the length of the chain. For a chain of one million transactions the proof size will be hundreds of megabytes. Even in high-fee ledgers such as Bitcoin, transaction chains of this size may grow over time.

### SUMMARY

According to one aspect disclosed herein, there is provided a computer implemented method of providing proof of an ordered sequence of events, the method performed on a computing device and comprising: receiving a transaction; creating a further transaction to be sent to a further computing device; obtaining proof data associated with the further transaction that provides proof to the further computing device that the further transaction is linked to an initial transaction in a transaction chain comprising the transaction, wherein the initial transaction relates to an initial event in the ordered sequence of events, and the proof data comprises: (i) a proof; (ii) an identifier of the transaction; and (iii) a unique identifier of the initial transaction; and sending the further transaction and the proof data to the further computing device.

According to another aspect disclosed herein, there is provided a computer implemented method of verifying an ordered sequence of events, the method performed on a computing device and comprising: receiving a transaction from a further computing device; receiving, from the further computing device, proof data associated with the transaction, the proof data comprising: (i) a proof; (ii) an identifier of a previous transaction in the transaction chain; and (iii) a unique identifier of an initial transaction of the transaction chain, wherein the initial transaction relates to an initial event in the ordered sequence of events; and verifying that the transaction is linked to the initial transaction in the transaction chain using the proof, the identifier of a previous transaction in the transaction chain, the unique identifier of the initial transaction, and a verification key.

Zero-Knowledge Proofs (ZKPs) are a method by which a party, known as the prover, may prove to another party, known as the verifier, that a statement is true, without revealing any information beside the fact that the statement is true. In embodiments of the present disclosure, a ZKP is generated to provide proof that two transactions are linked through an unbroken transaction chain.

Embodiments of the present disclosure have a number of applications. For example, embodiments of the present disclosure can be used to determine the current state of the bitcoin network with only several kilobytes. If a new blockchain node would like to enter the bitcoin network, they are faced with downloading hundreds of gigabytes of data and verifying that all transactions from the genesis block are indeed correct. Embodiments of the present disclosure can be used to construct a proof to verify the entirety of the bitcoin blockchain in one single function. This could be done at the level of block headers or the transaction DAG itself.

### BRIEF DESCRIPTION OF THE DRAWINGS

To assist understanding of embodiments of the present disclosure and to show how such embodiments may be put into effect, reference is made, by way of example only, to the accompanying drawings in which:

FIG. 1 is a schematic block diagram of a system for implementing a blockchain,

FIG. 2 schematically illustrates some examples of transactions which may be recorded in a blockchain,

FIG. 3A is a schematic block diagram of a client application,

FIG. 3B is a schematic mock-up of an example user interface that may be presented by the client application of FIG. 3A,

FIG. 4 illustrates a primary transaction chain;

FIG. 5 is schematic representation of a typical Bitcoin transaction;

FIG. 6 illustrates transactions of a transaction chain transmitted between user computer devices;

FIGS. 7a and 7b illustrate a method of providing proof of an ordered sequence of events in response to receiving an initial transaction;

FIG. 8 illustrates a method of verifying an ordered sequence of events; and

FIGS. 9a and 9b illustrate a method of providing proof of an ordered sequence of events in response to receiving a transaction is not an initial transaction of a transaction chain.

### DETAILED DESCRIPTION OF EMBODIMENTS

### Example System Overview

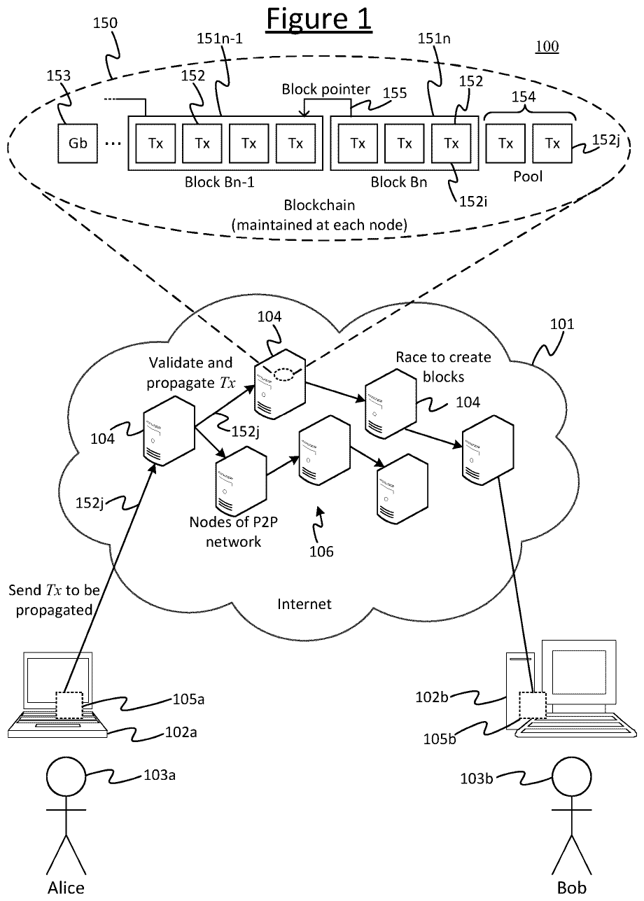

FIG. 1 shows an example system 100 for implementing a blockchain 150. The system 100 may comprise a packet-switched network 101, typically a wide-area internetwork such as the Internet. The packet-switched network 101 comprises a plurality of blockchain nodes 104 that may be arranged to form a peer-to-peer (P2P) network 106 within the packet-switched network 101. Whilst not illustrated, the blockchain nodes 104 may be arranged as a near-complete graph. Each blockchain node 104 is therefore highly connected to other blockchain nodes 104.

Each blockchain node 104 comprises computer equipment of a peer, with different ones of the nodes 104 belonging to different peers. Each blockchain node 104 comprises processing apparatus comprising one or more processors, e.g. one or more central processing units (CPUs), accelerator processors, application specific processors and/or field programmable gate arrays (FPGAs), and other equipment such as application specific integrated circuits (ASICs). Each node also comprises memory, i.e. computer-readable storage in the form of a non-transitory computer-readable medium or media.

The memory may comprise one or more memory units employing one or more memory media, e.g. a magnetic medium such as a hard disk; an electronic medium such as a solid-state drive (SSD), flash memory or EEPROM; and/or an optical medium such as an optical disk drive.

The blockchain 150 comprises a chain of blocks of data 151, wherein a respective copy of the blockchain 150 is maintained at each of a plurality of blockchain nodes 104 in the distributed or blockchain network 106. As mentioned above, maintaining a copy of the blockchain 150 does not necessarily mean storing the blockchain 150 in full. Instead, the blockchain 150 may be pruned of data so long as each blockchain node 150 stores the block header (discussed below) of each block 151. Each block 151 in the chain comprises one or more transactions 152, wherein a transaction in this context refers to a kind of data structure. The nature of the data structure will depend on the type of transaction protocol used as part of a transaction model or scheme. A given blockchain will use one particular transaction protocol throughout. In one common type of transaction protocol, the data structure of each transaction 152 comprises at least one input and at least one output. Each output specifies an amount representing a quantity of a digital asset as property, an example of which is a user 103 to whom the output is cryptographically locked (requiring a signature or other solution of that user in order to be unlocked and thereby redeemed or spent). Each input points back to the output of a preceding transaction 152, thereby linking the transactions.

Each block 151 also comprises a block pointer 155 pointing back to the previously created block 151 in the chain so as to define a sequential order to the blocks 151. Each transaction 152 (other than a coinbase transaction) comprises a pointer back to a previous transaction so as to define an order to sequences of transactions (N.B. sequences of transactions 152 are allowed to branch). The chain of blocks 151 goes all the way back to a genesis block (Gb) 153 which was the first block in the chain. One or more original transactions 152 early on in the chain 150 pointed to the genesis block 153 rather than a preceding transaction.

Each of the blockchain nodes 104 is configured to forward transactions 152 to other blockchain nodes 104, and thereby cause transactions 152 to be propagated throughout the network 106. Each blockchain node 104 is configured to create blocks 151 and to store a respective copy of the same blockchain 150 in their respective memory. Each blockchain node 104 also maintains an ordered set (or “pool”) 154 of transactions 152 waiting to be incorporated into blocks 151. The ordered pool 154 is often referred to as a “mempool”. This term herein is not intended to limit to any particular blockchain, protocol or model. It refers to the ordered set of transactions which a node 104 has accepted as valid and for which the node 104 is obliged not to accept any other transactions attempting to spend the same output.

In a given present transaction 152j, the (or each) input comprises a pointer referencing the output of a preceding transaction 152i in the sequence of transactions, specifying that this output is to be redeemed or “spent” in the present transaction 152j. In general, the preceding transaction could be any transaction in the ordered set 154 or any block 151. The preceding transaction 152i need not necessarily exist at the time the present transaction 152j is created or even sent to the network 106, though the preceding transaction 152i will need to exist and be validated in order for the present transaction to be valid. Hence “preceding” herein refers to a predecessor in a logical sequence linked by pointers, not necessarily the time of creation or sending in a temporal sequence, and hence it does not necessarily exclude that the transactions 152i, 152j be created or sent out-of-order (see discussion below on orphan transactions). The preceding transaction 152i could equally be called the antecedent or predecessor transaction.

The input of the present transaction 152j also comprises the input authorisation, for example the signature of the user 103a to whom the output of the preceding transaction 152i is locked. In turn, the output of the present transaction 152j can be cryptographically locked to a new user or entity 103b. The present transaction 152j can thus transfer the amount defined in the input of the preceding transaction 152i to the new user or entity 103b as defined in the output of the present transaction 152j. In some cases a transaction 152 may have multiple outputs to split the input amount between multiple users or entities (one of whom could be the original user or entity 103a in order to give change). In some cases a transaction can also have multiple inputs to gather together the amounts from multiple outputs of one or more preceding transactions, and redistribute to one or more outputs of the current transaction.

According to an output-based transaction protocol such as bitcoin, when a party 103, such as an individual user or an organization, wishes to enact a new transaction 152j (either manually or by an automated process employed by the party), then the enacting party sends the new transaction from its computer terminal 102 to a recipient. The enacting party or the recipient will eventually send this transaction to one or more of the blockchain nodes 104 of the network 106 (which nowadays are typically servers or data centres, but could in principle be other user terminals). It is also not excluded that the party 103 enacting the new transaction 152j could send the transaction directly to one or more of the blockchain nodes 104 and, in some examples, not to the recipient. A blockchain node 104 that receives a transaction checks whether the transaction is valid according to a blockchain node protocol which is applied at each of the blockchain nodes 104. The blockchain node protocol typically requires the blockchain node 104 to check that a cryptographic signature in the new transaction 152j matches the expected signature, which depends on the previous transaction 152i in an ordered sequence of transactions 152. In such an output-based transaction protocol, this may comprise checking that the cryptographic signature or other authorisation of the party 103 included in the input of the new transaction 152j matches a condition defined in the output of the preceding transaction 152i which the new transaction assigns, wherein this condition typically comprises at least checking that the cryptographic signature or other authorisation in the input of the new transaction 152j unlocks the output of the previous transaction 152i to which the input of the new transaction is linked to. The condition may be at least partially defined by a script included in the output of the preceding transaction 152i. Alternatively it could simply be fixed by the blockchain node protocol alone, or it could be due to a combination of these. Either way, if the new transaction 152j is valid, the blockchain node 104 forwards it to one or more other blockchain nodes 104 in the blockchain network 106. These other blockchain nodes 104 apply the same test according to the same blockchain node protocol, and so forward the new transaction 152j on to one or more further nodes 104, and so forth. In this way the new transaction is propagated throughout the network of blockchain nodes 104.

In an output-based model, the definition of whether a given output (e.g. UTXO) is assigned (e.g. spent) is whether it has yet been validly redeemed by the input of another, onward transaction 152j according to the blockchain node protocol. Another condition for a transaction to be valid is that the output of the preceding transaction 152i which it attempts to redeem has not already been redeemed by another transaction. Again if not valid, the transaction 152j will not be propagated (unless flagged as invalid and propagated for alerting) or recorded in the blockchain 150. This guards against double-spending whereby the transactor tries to assign the output of the same transaction more than once. An account-based model on the other hand guards against double-spending by maintaining an account balance. Because again there is a defined order of transactions, the account balance has a single defined state at any one time.

In addition to validating transactions, blockchain nodes 104 also race to be the first to create blocks of transactions in a process commonly referred to as mining, which is supported by “proof-of-work”. At a blockchain node 104, new transactions are added to an ordered pool 154 of valid transactions that have not yet appeared in a block 151 recorded on the blockchain 150. The blockchain nodes then race to assemble a new valid block 151 of transactions 152 from the ordered set of transactions 154 by attempting to solve a cryptographic puzzle. Typically this comprises searching for a “nonce” value such that when the nonce is concatenated with a representation of the ordered pool of pending transactions 154 and hashed, then the output of the hash meets a predetermined condition. E.g. the predetermined condition may be that the output of the hash has a certain predefined number of leading zeros. Note that this is just one particular type of proof-of-work puzzle, and other types are not excluded. A property of a hash function is that it has an unpredictable output with respect to its input. Therefore this search can only be performed by brute force, thus consuming a substantive amount of processing resource at each blockchain node 104 that is trying to solve the puzzle.

The first blockchain node 104 to solve the puzzle announces this to the network 106, providing the solution as proof which can then be easily checked by the other blockchain nodes 104 in the network (once given the solution to a hash it is straightforward to check that it causes the output of the hash to meet the condition). The first blockchain node 104 propagates a block to a threshold consensus of other nodes that accept the block and thus enforce the protocol rules. The ordered set of transactions 154 then becomes recorded as a new block 151 in the blockchain 150 by each of the blockchain nodes 104.

A block pointer 155 is also assigned to the new block 151n pointing back to the previously created block 151n-1 in the chain. The significant amount of effort, for example in the form of hash, required to create a proof-of-work solution signals the intent of the first node 104 to follow the rules of the blockchain protocol. Such rules include not accepting a transaction as valid if it assigns the same output as a previously validated transaction, otherwise known as double-spending. Once created, the block 151 cannot be modified since it is recognized and maintained at each of the blockchain nodes 104 in the blockchain network 106. The block pointer 155 also imposes a sequential order to the blocks 151. Since the transactions 152 are recorded in the ordered blocks at each blockchain node 104 in a network 106, this therefore provides an immutable public ledger of the transactions.

Note that different blockchain nodes 104 racing to solve the puzzle at any given time may be doing so based on different snapshots of the pool of yet-to-be published transactions 154 at any given time, depending on when they started searching for a solution or the order in which the transactions were received. Whoever solves their respective puzzle first defines which transactions 152 are included in the next new block 151n and in which order, and the current pool 154 of unpublished transactions is updated. The blockchain nodes 104 then continue to race to create a block from the newly-defined ordered pool of unpublished transactions 154, and so forth. A protocol also exists for resolving any “fork” that may arise, which is where two blockchain nodes 104 solve their puzzle within a very short time of one another such that a conflicting view of the blockchain gets propagated between nodes 104. In short, whichever prong of the fork grows the longest becomes the definitive blockchain 150. Note this should not affect the users or agents of the network as the same transactions will appear in both forks.

According to the bitcoin blockchain (and most other blockchains) a node that successfully constructs a new block 104 is granted the ability to newly assign an additional, accepted amount of the digital asset in a new special kind of transaction which distributes an additional defined quantity of the digital asset (as opposed to an inter-agent, or inter-user transaction which transfers an amount of the digital asset from one agent or user to another). This special type of transaction is usually referred to as a “coinbase transaction”, but may also be termed an “initiation transaction” or “generation transaction”. It typically forms the first transaction of the new block 151n. The proof-of-work signals the intent of the node that constructs the new block to follow the protocol rules allowing this special transaction to be redeemed later. The blockchain protocol rules may require a maturity period, for example 100 blocks, before this special transaction may be redeemed. Often a regular (non-generation) transaction 152 will also specify an additional transaction fee in one of its outputs, to further reward the blockchain node 104 that created the block 151n in which that transaction was published. This fee is normally referred to as the “transaction fee”, and is discussed blow.

Due to the resources involved in transaction validation and publication, typically at least each of the blockchain nodes 104 takes the form of a server comprising one or more physical server units, or even whole a data centre. However in principle any given blockchain node 104 could take the form of a user terminal or a group of user terminals networked together.

The memory of each blockchain node 104 stores software configured to run on the processing apparatus of the blockchain node 104 in order to perform its respective role or roles and handle transactions 152 in accordance with the blockchain node protocol. It will be understood that any action attributed herein to a blockchain node 104 may be performed by the software run on the processing apparatus of the respective computer equipment. The node software may be implemented in one or more applications at the application layer, or a lower layer such as the operating system layer or a protocol layer, or any combination of these.

Also connected to the network 101 is the computer equipment 102 of each of a plurality of parties 103 in the role of consuming users. These users may interact with the blockchain network 106 but do not participate in validating transactions or constructing blocks. Some of these users or agents 103 may act as senders and recipients in transactions. Other users may interact with the blockchain 150 without necessarily acting as senders or recipients. For instance, some parties may act as storage entities that store a copy of the blockchain 150 (e.g. having obtained a copy of the blockchain from a blockchain node 104).

Some or all of the parties 103 may be connected as part of a different network, e.g. a network overlaid on top of the blockchain network 106. Users of the blockchain network (often referred to as “clients”) may be said to be part of a system that includes the blockchain network 106; however, these users are not blockchain nodes 104 as they do not perform the roles required of the blockchain nodes. Instead, each party 103 may interact with the blockchain network 106 and thereby utilize the blockchain 150 by connecting to (i.e. communicating with) a blockchain node 106. Two parties 103 and their respective equipment 102 are shown for illustrative purposes: a first party 103a and his/her respective computer equipment 102a, and a second party 103b and his/her respective computer equipment 102b. It will be understood that many more such parties 103 and their respective computer equipment 102 may be present and participating in the system 100, but for convenience they are not illustrated. Each party 103 may be an individual or an organization. Purely by way of illustration the first party 103a is referred to herein as Alice and the second party 103b is referred to as Bob, but it will be appreciated that this is not limiting and any reference herein to Alice or Bob may be replaced with “first party” and “second “party” respectively.

The computer equipment 102 of each party 103 comprises respective processing apparatus comprising one or more processors, e.g. one or more CPUs, GPUs, other accelerator processors, application specific processors, and/or FPGAs. The computer equipment 102 of each party 103 further comprises memory, i.e. computer-readable storage in the form of a non-transitory computer-readable medium or media. This memory may comprise one or more memory units employing one or more memory media, e.g. a magnetic medium such as hard disk; an electronic medium such as an SSD, flash memory or EEPROM; and/or an optical medium such as an optical disc drive. The memory on the computer equipment 102 of each party 103 stores software comprising a respective instance of at least one client application 105 arranged to run on the processing apparatus. It will be understood that any action attributed herein to a given party 103 may be performed using the software run on the processing apparatus of the respective computer equipment 102. The computer equipment 102 of each party 103 comprises at least one user terminal, e.g. a desktop or laptop computer, a tablet, a smartphone, or a wearable device such as a smartwatch. The computer equipment 102 of a given party 103 may also comprise one or more other networked resources, such as cloud computing resources accessed via the user terminal.

The client application 105 may be initially provided to the computer equipment 102 of any given party 103 on suitable computer-readable storage medium or media, e.g. downloaded from a server, or provided on a removable storage device such as a removable SSD, flash memory key, removable EEPROM, removable magnetic disk drive, magnetic floppy disk or tape, optical disk such as a CD or DVD ROM, or a removable optical drive, etc.

The client application 105 comprises at least a “wallet” function. This has two main functionalities. One of these is to enable the respective party 103 to create, authorise (for example sign) and send transactions 152 to one or more bitcoin nodes 104 to then be propagated throughout the network of blockchain nodes 104 and thereby included in the blockchain 150. The other is to report back to the respective party the amount of the digital asset that he or she currently owns. In an output-based system, this second functionality comprises collating the amounts defined in the outputs of the various 152 transactions scattered throughout the blockchain 150 that belong to the party in question.

Note: whilst the various client functionality may be described as being integrated into a given client application 105, this is not necessarily limiting and instead any client functionality described herein may instead be implemented in a suite of two or more distinct applications, e.g. interfacing via an API, or one being a plug-in to the other. More generally the client functionality could be implemented at the application layer or a lower layer such as the operating system, or any combination of these. The following will be described in terms of a client application 105 but it will be appreciated that this is not limiting.

The instance of the client application or software 105 on each computer equipment 102 is operatively coupled to at least one of the blockchain nodes 104 of the network 106. This enables the wallet function of the client 105 to send transactions 152 to the network 106. The client 105 is also able to contact blockchain nodes 104 in order to query the blockchain 150 for any transactions of which the respective party 103 is the recipient (or indeed inspect other parties' transactions in the blockchain 150, since in embodiments the blockchain 150 is a public facility which provides trust in transactions in part through its public visibility). The wallet function on each computer equipment 102 is configured to formulate and send transactions 152 according to a transaction protocol. As set out above, each blockchain node 104 runs software configured to validate transactions 152 according to the blockchain node protocol, and to forward transactions 152 in order to propagate them throughout the blockchain network 106.

The transaction protocol and the node protocol correspond to one another, and a given transaction protocol goes with a given node protocol, together implementing a given transaction model. The same transaction protocol is used for all transactions 152 in the blockchain 150. The same node protocol is used by all the nodes 104 in the network 106.

When a given party 103, say Alice, wishes to send a new transaction 152j to be included in the blockchain 150, then she formulates the new transaction in accordance with the relevant transaction protocol (using the wallet function in her client application 105). She then sends the transaction 152 from the client application 105 to one or more blockchain nodes 104 to which she is connected. E.g. this could be the blockchain node 104 that is best connected to Alice's computer 102. When any given blockchain node 104 receives a new transaction 152j, it handles it in accordance with the blockchain node protocol and its respective role. This comprises first checking whether the newly received transaction 152j meets a certain condition for being “valid”, examples of which will be discussed in more detail shortly. In some transaction protocols, the condition for validation may be configurable on a per-transaction basis by scripts included in the transactions 152. Alternatively the condition could simply be a built-in feature of the node protocol, or be defined by a combination of the script and the node protocol.

On condition that the newly received transaction 152j passes the test for being deemed valid (i.e. on condition that it is “validated”), any blockchain node 104 that receives the transaction 152j will add the new validated transaction 152 to the ordered set of transactions 154 maintained at that blockchain node 104. Further, any blockchain node 104 that receives the transaction 152j will propagate the validated transaction 152 onward to one or more other blockchain nodes 104 in the network 106. Since each blockchain node 104 applies the same protocol, then assuming the transaction 152j is valid, this means it will soon be propagated throughout the whole network 106.

Once admitted to the ordered pool of pending transactions 154 maintained at a given blockchain node 104, that blockchain node 104 will start competing to solve the proof-of-work puzzle on the latest version of their respective pool of 154 including the new transaction 152 (recall that other blockchain nodes 104 may be trying to solve the puzzle based on a different pool of transactions 154, but whoever gets there first will define the set of transactions that are included in the latest block 151. Eventually a blockchain node 104 will solve the puzzle for a part of the ordered pool 154 which includes Alice's transaction 152j). Once the proof-of-work has been done for the pool 154 including the new transaction 152j, it immutably becomes part of one of the blocks 151 in the blockchain 150. Each transaction 152 comprises a pointer back to an earlier transaction, so the order of the transactions is also immutably recorded.

Different blockchain nodes 104 may receive different instances of a given transaction first and therefore have conflicting views of which instance is ‘valid’ before one instance is published in a new block 151, at which point all blockchain nodes 104 agree that the published instance is the only valid instance. If a blockchain node 104 accepts one instance as valid, and then discovers that a second instance has been recorded in the blockchain 150 then that blockchain node 104 must accept this and will discard (i.e. treat as invalid) the instance which it had initially accepted (i.e. the one that has not been published in a block 151).

An alternative type of transaction protocol operated by some blockchain networks may be referred to as an “account-based” protocol, as part of an account-based transaction model. In the account-based case, each transaction does not define the amount to be transferred by referring back to the UTXO of a preceding transaction in a sequence of past transactions, but rather by reference to an absolute account balance. The current state of all accounts is stored, by the nodes of that network, separate to the blockchain and is updated constantly. In such a system, transactions are ordered using a running transaction tally of the account (also called the “position”). This value is signed by the sender as part of their cryptographic signature and is hashed as part of the transaction reference calculation. In addition, an optional data field may also be signed the transaction. This data field may point back to a previous transaction, for example if the previous transaction ID is included in the data field.

### UTXO-Based Model

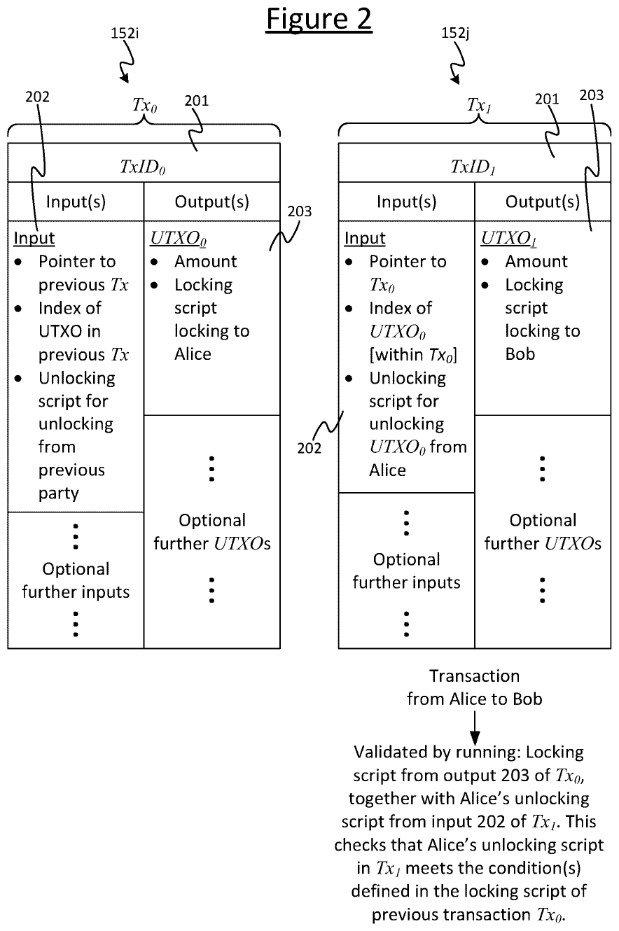

FIG. 2 illustrates an example transaction protocol. This is an example of a UTXO-based protocol. A transaction 152 (abbreviated “Tx”) is the fundamental data structure of the blockchain 150 (each block 151 comprising one or more transactions 152). The following will be described by reference to an output-based or “UTXO” based protocol. However, this is not limiting to all possible embodiments. Note that while the example UTXO-based protocol is described with reference to bitcoin, it may equally be implemented on other example blockchain networks.

In a UTXO-based model, each transaction (“Tx”) 152 comprises a data structure comprising one or more inputs 202, and one or more outputs 203. Each output 203 may comprise an unspent transaction output (UTXO), which can be used as the source for the input 202 of another new transaction (if the UTXO has not already been redeemed). The UTXO includes a value specifying an amount of a digital asset. This represents a set number of tokens on the distributed ledger. The UTXO may also contain the transaction ID of the transaction from which it came, amongst other information. The transaction data structure may also comprise a header 201, which may comprise an indicator of the size of the input field(s) 202 and output field(s) 203. The header 201 may also include an ID of the transaction. In embodiments the transaction ID is the hash of the transaction data (excluding the transaction ID itself) and stored in the header 201 of the raw transaction 152 submitted to the nodes 104.

Say Alice 103a wishes to create a transaction 152j transferring an amount of the digital asset in question to Bob 103b. In FIG. 2 Alice's new transaction 152j is labelled “Tx1”. It takes an amount of the digital asset that is locked to Alice in the output 203 of a preceding transaction 152i in the sequence, and transfers at least some of this to Bob. The preceding transaction 152i is labelled “Tx0” in FIG. 2. Tx0 and Tx1 are just arbitrary labels. They do not necessarily mean that Tx0 is the first transaction in the blockchain 151, nor that Tx1 is the immediate next transaction in the pool 154. Tx1 could point back to any preceding (i.e. antecedent) transaction that still has an unspent output 203 locked to Alice.

The preceding transaction Tx0 may already have been validated and included in a block 151 of the blockchain 150 at the time when Alice creates her new transaction Tx1, or at least by the time she sends it to the network 106. It may already have been included in one of the blocks 151 at that time, or it may be still waiting in the ordered set 154 in which case it will soon be included in a new block 151. Alternatively Tx0 and Tx1 could be created and sent to the network 106 together, or Tx0 could even be sent after Tx1 if the node protocol allows for buffering “orphan” transactions. The terms “preceding” and “subsequent” as used herein in the context of the sequence of transactions refer to the order of the transactions in the sequence as defined by the transaction pointers specified in the transactions (which transaction points back to which other transaction, and so forth). They could equally be replaced with “predecessor” and “successor”, or “antecedent” and “descendant”, “parent” and “child”, or such like. It does not necessarily imply an order in which they are created, sent to the network 106, or arrive at any given blockchain node 104. Nevertheless, a subsequent transaction (the descendent transaction or “child”) which points to a preceding transaction (the antecedent transaction or “parent”) will not be validated until and unless the parent transaction is validated. A child that arrives at a blockchain node 104 before its parent is considered an orphan. It may be discarded or buffered for a certain time to wait for the parent, depending on the node protocol and/or node behaviour.

One of the one or more outputs 203 of the preceding transaction Tx0 comprises a particular UTXO, labelled here UTXO0. Each UTXO comprises a value specifying an amount of the digital asset represented by the UTXO, and a locking script which defines a condition which must be met by an unlocking script in the input 202 of a subsequent transaction in order for the subsequent transaction to be validated, and therefore for the UTXO to be successfully redeemed. Typically the locking script locks the amount to a particular party (the beneficiary of the transaction in which it is included). I.e. the locking script defines an unlocking condition, typically comprising a condition that the unlocking script in the input of the subsequent transaction comprises the cryptographic signature of the party to whom the preceding transaction is locked.

The locking script (aka scriptPubKey) is a piece of code written in the domain specific language recognized by the node protocol. A particular example of such a language is called “Script” (capital S) which is used by the blockchain network. The locking script specifies what information is required to spend a transaction output 203, for example the requirement of Alice's signature. Unlocking scripts appear in the outputs of transactions. The unlocking script (aka scriptSig) is a piece of code written the domain specific language that provides the information required to satisfy the locking script criteria. For example, it may contain Bob's signature. Unlocking scripts appear in the input 202 of transactions.

So in the example illustrated, UTXO0 in the output 203 of Tx0 comprises a locking script [Checksig PA] which requires a signature Sig PA of Alice in order for UTXO0 to be redeemed (strictly, in order for a subsequent transaction attempting to redeem UTXO0 to be valid). [Checksig PA] contains a representation (i.e. a hash) of the public key PA from a public-private key pair of Alice. The input 202 of Tx1 comprises a pointer pointing back to Tx1 (e.g. by means of its transaction ID, TxID0, which in embodiments is the hash of the whole transaction Tx0). The input 202 of Tx1 comprises an index identifying UTXO0 within Tx0, to identify it amongst any other possible outputs of Tx0. The input 202 of Tx1 further comprises an unlocking script <Sig PA> which comprises a cryptographic signature of Alice, created by Alice applying her private key from the key pair to a predefined portion of data (sometimes called the “message” in cryptography). The data (or “message”) that needs to be signed by Alice to provide a valid signature may be defined by the locking script, or by the node protocol, or by a combination of these.

When the new transaction Tx1 arrives at a blockchain node 104, the node applies the node protocol. This comprises running the locking script and unlocking script together to check whether the unlocking script meets the condition defined in the locking script (where this condition may comprise one or more criteria). In embodiments this involves concatenating the two scripts:
<Sig PA><PA>| | [Checksig PA]

where “∥” represents a concatenation and “< . . . >” means place the data on the stack, and “[ . . . ]” is a function comprised by the locking script (in this example a stack-based language). Equivalently the scripts may be run one after the other, with a common stack, rather than concatenating the scripts. Either way, when run together, the scripts use the public key PA of Alice, as included in the locking script in the output of Tx0, to authenticate that the unlocking script in the input of Tx1 contains the signature of Alice signing the expected portion of data. The expected portion of data itself (the “message”) also needs to be included in order to perform this authentication. In embodiments the signed data comprises the whole of Tx1 (so a separate element does not need to be included specifying the signed portion of data in the clear, as it is already inherently present).

The details of authentication by public-private cryptography will be familiar to a person skilled in the art. Basically, if Alice has signed a message using her private key, then given Alice's public key and the message in the clear, another entity such as a node 104 is able to authenticate that the message must have been signed by Alice. Signing typically comprises hashing the message, signing the hash, and tagging this onto the message as a signature, thus enabling any holder of the public key to authenticate the signature. Note therefore that any reference herein to signing a particular piece of data or part of a transaction, or such like, can in embodiments mean signing a hash of that piece of data or part of the transaction.

If the unlocking script in Tx1 meets the one or more conditions specified in the locking script of Tx0 (so in the example shown, if Alice's signature is provided in Tx1 and authenticated), then the blockchain node 104 deems Tx1 valid. This means that the blockchain node 104 will add Tx1 to the ordered pool of pending transactions 154. The blockchain node 104 will also forward the transaction Tx1 to one or more other blockchain nodes 104 in the network 106, so that it will be propagated throughout the network 106. Once Tx1 has been validated and included in the blockchain 150, this defines UTXO0 from Tx0 as spent. Note that Tx1can only be valid if it spends an unspent transaction output 203. If it attempts to spend an output that has already been spent by another transaction 152, then Tx1 will be invalid even if all the other conditions are met. Hence the blockchain node 104 also needs to check whether the referenced UTXO in the preceding transaction Tx0 is already spent (i.e. whether it has already formed a valid input to another valid transaction). This is one reason why it is important for the blockchain 150 to impose a defined order on the transactions 152. In practice a given blockchain node 104 may maintain a separate database marking which UTXOs 203 in which transactions 152 have been spent, but ultimately what defines whether a UTXO has been spent is whether it has already formed a valid input to another valid transaction in the blockchain 150.

If the total amount specified in all the outputs 203 of a given transaction 152 is greater than the total amount pointed to by all its inputs 202, this is another basis for invalidity in most transaction models. Therefore such transactions will not be propagated nor included in a block 151.

Note that in UTXO-based transaction models, a given UTXO needs to be spent as a whole. It cannot “leave behind” a fraction of the amount defined in the UTXO as spent while another fraction is spent. However the amount from the UTXO can be split between multiple outputs of the next transaction. E.g. the amount defined in UTXO₀ in T_{X0} can be split between multiple UTXOs in Tx1. Hence if Alice does not want to give Bob all of the amount defined in UTXO₀, she can use the remainder to give herself change in a second output of T_{X1}, or pay another party.

In practice Alice will also usually need to include a fee for the bitcoin node 104 that successfully includes her transaction 104 in a block 151. If Alice does not include such a fee, T_{X0} may be rejected by the blockchain nodes 104, and hence although technically valid, may not be propagated and included in the blockchain 150 (the node protocol does not force blockchain nodes 104 to accept transactions 152 if they don't want). In some protocols, the transaction fee does not require its own separate output 203 (i.e. does not need a separate UTXO). Instead any difference between the total amount pointed to by the input(s) 202 and the total amount of specified in the output(s) 203 of a given transaction 152 is automatically given to the blockchain node 104 publishing the transaction. E.g. say a pointer to UTXO₀ is the only input to T_{X1}, and T_{X1} has only one output UTXO₁. If the amount of the digital asset specified in UTXO₀ is greater than the amount specified in UTXO₁, then the difference may be assigned by the node 104 that wins the proof-of-work race to create the block containing UTXO₁. Alternatively or additionally however, it is not necessarily excluded that a transaction fee could be specified explicitly in its own one of the UTXOs 203 of the transaction 152.

Alice and Bob's digital assets consist of the UTXOs locked to them in any transactions 152 anywhere in the blockchain 150. Hence typically, the assets of a given party 103 are scattered throughout the UTXOs of various transactions 152 throughout the blockchain 150. There is no one number stored anywhere in the blockchain 150 that defines the total balance of a given party 103. It is the role of the wallet function in the client application 105 to collate together the values of all the various UTXOs which are locked to the respective party and have not yet been spent in another onward transaction. It can do this by querying the copy of the blockchain 150 as stored at any of the bitcoin nodes 104.

Note that the script code is often represented schematically (i.e. not using the exact language). For example, one may use operation codes (opcodes) to represent a particular function. “OP_. . . ” refers to a particular opcode of the Script language. As an example, OP_RETURN is an opcode of the Script language that when preceded by OP_FALSE at the beginning of a locking script creates an unspendable output of a transaction that can store data within the transaction, and thereby record the data immutably in the blockchain 150. E.g. the data could comprise a document which it is desired to store in the blockchain.

Typically an input of a transaction contains a digital signature corresponding to a public key PA. In embodiments this is based on the ECDSA using the elliptic curve secp256k1. A digital signature signs a particular piece of data. In some embodiments, for a given transaction the signature will sign part of the transaction input, and some or all of the transaction outputs. The particular parts of the outputs it signs depends on the SIGHASH flag. The SIGHASH flag is usually a 4-byte code included at the end of a signature to select which outputs are signed (and thus fixed at the time of signing).

The locking script is sometimes called “scriptPubKey” referring to the fact that it typically comprises the public key of the party to whom the respective transaction is locked. The unlocking script is sometimes called “scriptSig” referring to the fact that it typically supplies the corresponding signature. However, more generally it is not essential in all applications of a blockchain 150 that the condition for a UTXO to be redeemed comprises authenticating a signature. More generally the scripting language could be used to define any one or more conditions. Hence the more general terms “locking script” and “unlocking script” may be preferred.

### Client Software

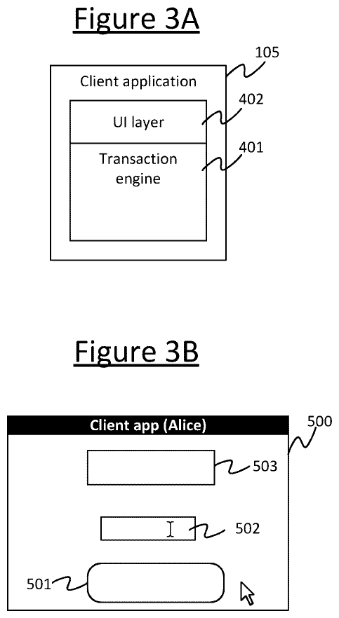

FIG. 3A illustrates an example implementation of the client application 105 for implementing embodiments of the presently disclosed scheme. The client application 105 comprises a transaction engine 401 and a user interface (UI) layer 402. The transaction engine 401 is configured to implement the underlying transaction-related functionality of the client 105, such as to formulate transactions 152, send transactions to one or more nodes 104 to be propagated through the blockchain network 106, in accordance with the schemes discussed above and as discussed in further detail shortly.

The UI layer 402 is configured to render a user interface via a user input/output (I/O) means of the respective user's computer equipment 102, including outputting information to the respective user 103 via a user output means of the equipment 102, and receiving inputs back from the respective user 103 via a user input means of the equipment 102. For example the user output means could comprise one or more display screens (touch or non-touch screen) for providing a visual output, one or more speakers for providing an audio output, and/or one or more haptic output devices for providing a tactile output, etc. The user input means could comprise for example the input array of one or more touch screens (the same or different as that/those used for the output means); one or more cursor-based devices such as mouse, trackpad or trackball; one or more microphones and speech or voice recognition algorithms for receiving a speech or vocal input; one or more gesture-based input devices for receiving the input in the form of manual or bodily gestures; or one or more mechanical buttons, switches or joysticks, etc.

Note: whilst the various functionality herein may be described as being integrated into the same client application 105, this is not necessarily limiting and instead they could be implemented in a suite of two or more distinct applications, e.g. one being a plug-in to the other or interfacing via an API (application programming interface). For instance, the functionality of the transaction engine 401 may be implemented in a separate application than the UI layer 402, or the functionality of a given module such as the transaction engine 401 could be split between more than one application. Nor is it excluded that some or all of the described functionality could be implemented at, say, the operating system layer. Where reference is made anywhere herein to a single or given application 105, or such like, it will be appreciated that this is just by way of example, and more generally the described functionality could be implemented in any form of software.

FIG. 3B gives a mock-up of an example of the user interface (UI) 500 which may be rendered by the UI layer 402 of the client application 105a on Alice's equipment 102a. It will be appreciated that a similar UI may be rendered by the client 105b on Bob's equipment 102b, or that of any other party.

By way of illustration FIG. 3B shows the UI 500 from Alice's perspective. The UI 500 may comprise one or more UI elements 501, 502, 502 rendered as distinct UI elements via the user output means.

For example, the UI elements may comprise one or more user-selectable elements 501 which may be, such as different on-screen buttons, or different options in a menu, or such like. The user input means is arranged to enable the user 103 (in this case Alice 103a) to select or otherwise operate one of the options, such as by clicking or touching the UI element on-screen, or speaking a name of the desired option (N.B. the term “manual” as used herein is meant only to contrast against automatic, and does not necessarily limit to the use of the hand or hands). The options enable the user (Alice) to formulate transactions 152 and send transactions to one or more nodes 104 to be propagated through the blockchain network 106

Alternatively or additionally, the UI elements may comprise one or more data entry fields 502, through which the user can formulate transactions 152 and send transactions to one or more nodes 104 to be propagated through the blockchain network 106. These data entry fields are rendered via the user output means, e.g. on-screen, and the data can be entered into the fields through the user input means, e.g. a keyboard or touchscreen. Alternatively the data could be received orally for example based on speech recognition.

Alternatively or additionally, the UI elements may comprise one or more information elements 503 output to output information to the user. E.g. this/these could be rendered on screen or audibly.

It will be appreciated that the particular means of rendering the various UI elements, selecting the options and entering data is not material. The functionality of these UI elements will be discussed in more detail shortly. It will also be appreciated that the UI 500 shown in FIG. 3B is only a schematized mock-up and in practice it may comprise one or more further UI elements, which for conciseness are not illustrated.

### Primary Transaction Chains

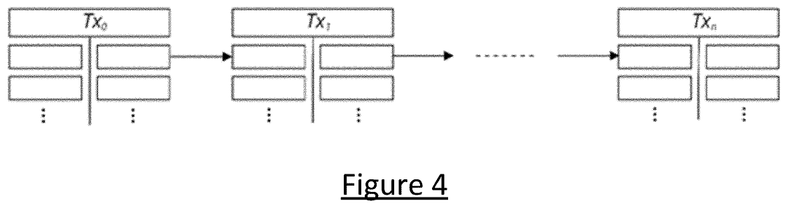

Consider a sequence of transactions where the first input of each transaction spends the first output of the previous transaction, we refer to this herein as a primary transaction chain, which is illustrated in FIG. 4.

Consider a scenario with a prover Alice and a verifier Bob. The first transaction Tx₀ is public data that is known to both Alice and Bob. Alice constructs the transaction Txₙ and sends it to Bob. Both parties now have two transactions (Tx₀, Txₙ).

Alice would like to prove the following statement to Bob: Statement 1: Tx₀ is linked to Txₙ through a primary transaction chain. If Bob accepts Alice's proof, he has the combination ((Tx₀, Txₙ), proofₙ).

Now consider a third actor Charlie. Bob creates a new transaction Txₙ₊₁ where the first input is the first output of Txₙ. He amends Alice's proof to create a new proof that Txₙ₊₁ is linked to Tx₀ through a primary transaction chain. He sends ((Tx₀, Txₙ₊₁), proofₙ₊₁) to Charlie.

Given that Tx₀ corresponds in this example to public data known to Alice, Bob and Charlie, the information flow can be seen as Alice sending Txₙ, proofₙ to Bob, and then Bob sending Txₙ₊₁, proofₙ₊₁ to Charlie.

Alice can easily prove Statement 1 by sending Bob every transaction in the chain. Bob can explicitly check that the first input of each transaction spends the first output of the previous transaction.

This solution has some advantages:
Design and implementation: Conceptually simple and easy to implement. It also does not involve sophisticated cryptographic algorithms.
Computation cost for Alice: Alice has no computational overheads.

However this solution has a number of disadvantages:
Communication cost: Linear in the size of the transaction chain. Alice must send the entire transaction chain to Bob. This may require a large amount of data to transfer. A typical transaction contains around 200 bytes, and a primary transaction chain has no upper bound in length. A chain of one million transactions will be ˜200 MB.
Computational cost for Bob: Given a transaction, Bob checks whether it is part of a transaction chain. If he has a Merkle root for the latest transaction, then he will also be ensured that miners have validated correctly.
Privacy cost: There is no privacy since all the data in all transactions are given to Bob. This is particularly important if some of the transactions have not been sent to the Bitcoin network yet. Even if all transactions have appeared on chain, giving Bob the transactions directly make it easier for him to identify sensitive information.
Repetition cost: When Bob sends his new proof to Charlie, Charlie must repeat the same calculations as Bob.

In accordance with embodiments if the present disclosure, Alice may use recursive zkSNARKs to prove the correctness of Statement 1. She does not need to send the entire transaction chain to Bob. Instead, she only sends a proof for the correctness of Statement 1.

This solution has a number of advantages:
Communication cost: Only small amount of data is sent to Bob due to succinct proof size of zkSNARKs. The size of the proof is very small and is independent of the number of transactions in the chain. For example, in a recursive zkSNARK it is around ˜3.5 kb for 128-bit security, even if there are one million transactions in the chain. This is so small that the proof may be inserted into a transaction. For example, Alice can recursively insert her proof into the transactions in the chain until the last transaction Txₙ.
Computational cost for Bob: The verification time for Bob is fast. He must only verify the proof.
Privacy cost: Alice has greater privacy control because she does not need to send all the transactions in the chain to Bob. This may be combined with other privacy controls such as obfuscating some of the data in Txₙ.
Repetition cost: Proofs can be built-up recursively. Bob can add a new transaction Txₙ₊₁ to the chain and create a new proof (which also includes the validation of the previous proof). Bob does not need to repeat the calculations for the proofs up to Txₙ. Charlie just needs to verify this new proof. He does not need to repeat any calculations performed by Bob.

### Transactions and Transaction Chains

In some embodiments of the present disclosure, the transactions are blockchain transactions (i.e. transactions which get committed to a blockchain 150 by way of interaction with the blockchain network 106).

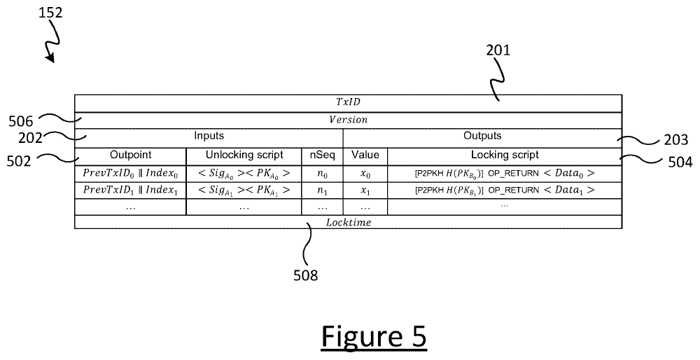

A schematic representation of a typical bitcoin transaction 152 is shown in FIG. 5.

A bitcoin transaction 152 has a unique identifier called a Transaction ID (TxID) 201 which is calculated by taking the double-SHA256 of the transaction data (all fields below TxID in FIG. 5). Note that the TxID is not considered part of the transaction itself.

A transaction input 202 contains a reference to previous transaction ID (PrevTxID) and an output index. The combination of a previous transaction ID and output index is referred to as an outpoint 502 and is labelled PrevTxID∥Index (see FIG. 5).

The set of all Bitcoin transactions forms a directed acyclic graph (DAG) where an edge connects an outpoint of one transaction to the input of another transaction. This DAG is often referred to as the Bitcoin ledger.

Data can be inserted into transactions at several positions. In FIG. 5, there is a data payload in each output locking script 504, which is a convenient position to insert data. These data payloads do not play a role in script execution as they are each positioned after an OP_RETURN statement. The locking scripts 504 contain a Pay-to-Public-Key-Hash (P2PKH) script pattern and data payload.

At a very high level, bitcoin defines the transaction generation routine as follows:

At a first step public and private key pairs are generated and destination addresses are derived from the public keys.

At a second step a new transaction is created. For the outputs (which are limited to 264) of the transaction, this involves getting destination addresses, creating a locking script for each address, and specifying the amount of satoshis assigned to each address. For the inputs (which are limited to 264) of the transaction this involves (i) identifying input UTXOs and inserting their transaction IDs (and output indices). These are referred to as PrevTxIDs; and (ii) generating the unlocking script for each input UTXO. This typically involves creating a digital signature (as in PKPKH) over the output and the input data (minus the unlocking scripts). Metadata is also generated such as version number 506, input and output count, and locktime 508. Finally a Transaction ID 201 is computed where: TxID=SHA256d (Tx) where Tx=(inputs, outputs, metadata). Note that the TxID is the double hash of transaction data that includes the PrevTxIDs. The transaction ID is used as an identifier for the transaction, and it is not part of the transaction itself.

At a third step the transaction is broadcast to the bitcoin network 106. This involves a computer equipment 102 getting a transaction and sending it to one or more blockchain nodes 104 on the bitcoin network 106. When a blockchain node 104 receives a transaction, it checks that it is valid and that none of the inputs have previously been assigned (i.e., not double-spent). The blockchain node 104 additionally checks whether a sufficient transaction fee has been included. If the transaction passes these checks, then it is accepted by the node and will be placed in an ordered pool 154 of transactions 152 waiting to be incorporated into blocks 151. The blockchain node 104 will also broadcast the transaction to other blockchain nodes. Once the transaction has been accepted by a sufficient number of blockchain nodes on the bitcoin network 106. it may be considered as safe since it is not feasible for a double spend to be accepted.

At a fourth step, after a time period (on average 10 minutes) a blockchain node 104 will publish a block containing the transaction. This provides further assurance that the transaction will not be double spent.

A transaction is valid if it satisfies the bitcoin ruleset in and of itself. This means that the transaction has the correct structure and that the unlocking scripts successfully unlock the outpoints, for example by providing a valid signature. There are additional consistency checks such as the value of the outputs not exceeding the inputs.

A valid transaction is a candidate to be accepted by the bitcoin network and published in a block. A valid transaction references previous transactions in its input list. These previous transactions may or may not be valid. However, if a transaction is accepted by a node on the Bitcoin network, then all previous transactions must be valid.

We refer to a “transaction chain” as an ordered set of transactions in which each transaction spends an output of the preceding transaction in the set. Due to the rules of the blockchain protocol, each transaction in the set must necessarily be created later in time than the preceding transaction in the set. This means that the order of the transactions in the chain can be understood as the order in time in which the transactions were created.

Below we provide mathematical definitions of a “transaction chain” and “primary transaction chain” in which Txt. Outpoints is defined as the ordered set of outpoints of the transaction Txᵢ.

We first provide a mathematical definition of a transaction chain. Let TxSet=(Tx₁, . . . . Txₙ) be an ordered set of valid transactions, with TxIDᵢ=SHA256d (Txᵢ). Then, the derived sequence TxSet′=(Txⱼ_{₁}, . . . , Txⱼⁿ) with Txⱼ_{ᵢ}∈TxSet is a transaction chain if for each jᵢ∈{2, . . . , n}, Txⱼ_{ᵢ}, Outpoints={ . . . , TxIDⱼ_{ᵢ}₋₁∥k, . . . } and Txⱼ_{ᵢ}₋₁:= [symbol] { [symbol] such that SHA256d ( [symbol] }=TxIDⱼ_{ᵢ}₋₁} where i∈{1, . . . , n} and 1≤k≤2⁶⁴.

Note that a transaction chain is unique up to the order of the transaction IDs as they are already known. However, if a collision on IDs occurs, then Txⱼ_{ᵢ}₋₁ is the first transaction with a colluding ID. Hence, a transaction chain may not necessarily be unique since hash collisions are possible.

We next provide a mathematical definition of a primary transaction chain. Given a transaction chain TxChain, if the first input of each transaction refers to the first output of the previous transaction, then we refer to this herein as a primary transaction chain. For a primary transaction chain, we have Txᵢ. Outpoints=(TxIDᵢ₋₁∥0, . . . ) for each i∈{2, . . . , n}.

We now refer to a first Lemma, Lemma 1.

Lemma 1: Assume that SHA256 is collision resistant (this property holds in particular when the compression function of SHA256 is collision resistant). It is computationally infeasible to find a transaction chain TxChain=(Tx₁, Tx₂, . . . , Txₙ) where any Txᵢ∈TxChain is repeated.

Proof: Since TxChain is a transaction chain we know that TxIDᵢ=SHA256d( . . . , TxIDᵢ₋₁, . . . ) for each i∈{2, . . . , n}. We can model the mapping of one TxIDᵢ₋₁ to TxIDᵢ as a random mapping based on SHA256. This is expected to have a cycle length of approximately 2127.

One of the consequences of Lemma 1 is that a transaction chain imposes a time-ordering on its elements. The next transaction in the chain must have been created after the previous transaction in the chain.

We will now present an important theorem (Theorem 1). It is useful because we can leverage the transaction processing that has been done by a bitcoin node 104. In means that in embodiments of the present disclosure it is not necessary to check the validity of each transaction in our recursive zkSNARK. As long as the final transaction has been accepted by the bitcoin network 106, and that each transaction has the correct structure, we know that they must be valid.

Theorem 1: Let TxSet=(Tx₁, Tx₂, . . . , Txₙ) be an ordered set and TxIDᵢ=SHA256d (Txᵢ). Suppose that each element Txt has an ordered set of outpoints Txᵢ. Outpoints in the correct position according to the Bitcoin ruleset, and that we have Txᵢ. Outpoints=( . . . , TxIDᵢ₋₁∥k, . . . ) for each i∈{2, . . . , n} and for some index k. If the final transaction Txₙ is accepted by a node on the Bitcoin network, then each element Txᵢ is a valid transaction and TxSet is a transaction chain. Moreover, if TxSet is a primary transaction chain then it is unique.

Proof: If Txₙ is accepted by a node A on the Bitcoin network, then all previous transactions are valid and have also been accepted by the node A. In particular, Txₙ₋₁ is a valid transaction and has been accepted by the node A. This argument is repeated back to Tx₁. This proves that each element Txᵢ is a valid transaction and TxSet is a transaction chain.

We now prove that if TxSet is a primary transaction chain then it is unique. We will prove this by induction for primary transaction chains of length N>1.

### N=2:

Consider a primary transaction chain with two elements (Tx₁, Tx₂). Let us assume that there is a second primary transaction chain (Tx₁, Tx₂, . . . , Tx′ₘ₋₁, Tx′ₘ) such that Tx′ₘ=Tx₂.

Since Tx′ₘ=Tx₂ we have

$${TxID}_{m}^{′} \cdot Outpoints = {TxID}_{2} \cdot Outpoints$$

and therefore

$${TxID}_{m}^{′} \cdot Outpoints = ( {TxID}_{1} ‖ 0 , … ) .$$

By the one-wayness and collision resistance of hash functions, Tx1 must be the previous transaction in the first outpoint of Tx′ₘ. Therefore, either m=2 and both primary chains are the same, or the second primary transaction chain must have the form (Tx₁, Tx′₂, . . . , Tx₁, Tx₂). Since Tx₁ is repeated we have a contradiction with Lemma 1. We conclude that (Tx₁, Tx₂) is a unique primary transaction chain.

### N=n−1:

By our inductive hypothesis, we assume that (Tx₁, Tx₂, . . . , Txₙ₋₁) is a unique primary transaction chain.

The elements (Txₙ₋₁, Txₙ) form a primary transaction chain of two elements. The chain is unique by the arguments of the case N=2.

We are left with two unique primary transaction chains (Tx₁, Tx₂, . . . , Txₙ₋₁) and (Txₙ₋₁, Txₙ). Hence, the combination (Tx₁, Tx₂, . . . , Txₙ) forms a unique primary transaction chain.

### Zero Knowledge Proofs

As noted above, a Zero Knowledge Proof (ZKP) can be used to prove knowledge of a secret without revealing any secret data.

Zero Knowledge Proofs shows the knowledge of a satisfying witness to some Non-deterministic Polynomial (NP) statements without disclosing anything about the witness. zkSNARKs use non-interactive arguments of knowledge which are arguments that enable a verifier to confirm that the prover does indeed know the witness.

A zkSNARK (Zero-Knowledge Succinct Non-Interactive Argument of Knowledge) is a Non-Interactive Zero-Knowledge (NIZK) proof of knowledge that is succinct and for which proofs are very short and easy to verify. The statement is represented in terms of logic circuits that is used to generate a proof of the statement. In the most efficient constructions, the verifier simply performs a constant number of group operations. A zkSNARK can be used to prove knowledge of a secret input w to an arbitrary function F for a given output. It uses a linear probabilistic proof, combined with zero knowledge techniques based on a bilinear pairing and the Discrete Logarithm Problem (DLP).

The concept of recursive zkSNARKS was initially started with Incrementally Verifiable Computation (IVC) where proofs not only attest to the correct execution of a computation but also the validity of a previous proof. Hence, a large and virtually unbounded amount of computation can be easily verified with a single proof.

In a general purpose zkSNARK construction, a prover creates a proof π that it knows some satisfying public input x and private input w to some relation R which is specified by an arithmetic circuit C. Note that the majority of use cases of zkSNARK constructions in the blockchain world are related to scalability rather than privacy. In this context, the zkSNARK constructions are flexible with the inputs, where the private input can be empty as well, i.e., w=⊥.

An arithmetic circuit C is used to represent the function F for which a ZKP is provided of a secret input given public inputs and outputs. The circuit is constructed from multiplication and addition gates. An output of a multiplication gate that is not an output of the whole circuit is labelled an auxiliary variable.

In a zkSNARK, the proof π attests to the fact that R (x, w)=1 meaning that the statement is indeed true. A verifier will then take the proof π and public input x, and output 1 if the proof is valid. However, this verification itself can also be expressed as a relation R′. Namely, we can express as R′ (x, π):=V (x, π) for all valid inputs to the verifier. Hence, it is possible to create proofs which attest to the validity of other proofs. The goal of recursive proof composition is to construct ZKPs that verify other ZKPs, which enables the aggregation of proofs. This is used in embodiments of the present disclosure as will be explained in more detail below.

The theorem (Theorem 2) expressed below ensures the existence of a Recursive zkSNARK given a zkSNARK construction.

Theorem 2: If there is a zkSNARK with a succinct verification and it is adaptively secure, then it is possible to recurse it in the sense that one can obtain the proof-carrying data primitive from it, using recursion.

Considering a set of system states S with an initial state s₀∈S, it is possible to construct a predicate Πₛ that evaluates to 1 on input state sᵢ (or a commitment to it) if and only if there exists a valid transition from some sᵢ to sᵢ₊₁. In the context of the present disclosure, a transaction will be considered a state, and Πᵢ evaluates to true for a valid transition from Txᵢ₋₁ to Txᵢ.

A proof carrying data (PCD) system comprises the following three algorithms:
Setup: Generate (Πₛ, 1^{k}) Key generation takes as input a predicate Πₛ and a security parameter k (i.e., the system has k-bit security), outputting proving and verification keys (pk, vk).
Prover: Prove (pk, sᵢ₊₁, TxSet, sᵢ, πᵢ, wᵢ)→πᵢ₊₁. The prover takes as input the proving key pk, the current and next state sᵢ, sᵢ₊₁, a witness wᵢ, a proof πᵢ that sᵢ is a valid state (which attests that the old proof is already valid) and a set of valid transactions t∈TxSet, outputting a proof πᵢ₊₁ that sᵢ→sᵢ₊₁ is a valid state transition.
Verifier: Verify(vk,Bᵢ,πᵢ)→Yes/No. When the verification key vk, a proof πᵢ and a commitment Bᵢ to state sᵢ are given, the verifier outputs “Yes” if πᵢ is a valid proof that state sᵢ is valid and outputs “No” with very high probability otherwise.

The proving and verification keys (pk, vk) may be created by an independent trusted party. This party needs to be trusted because with knowledge of the private key of the proving key pk fake proofs can be generated. Only one set of proving and verification keys (pk, vk) needs to be generated for one ZKP circuit. Therefore, if the ZKP circuit is constant for a particular use-case this key generation process just needs to be performed once. In some implementations, the proving and verification keys (pk, vk) may involve multiple different parties as part of key generation ceremony.

Note that in each iteration of the proof generation the prover and verifier may be different. In recursive proof constructions, a second prover does not need to trust the prover since it first verifies the previous proof before generating the new proof of the current state. This means that many different token processors (i.e. blockchain service providers such as NFT providers) can use the same token protocol without having to trust each other.

Without loss of generality, embodiments of the present disclosure are described with reference to the Halo framework from which different ZKP implementations can be used (e.g. Halo, Halo 2, Halo infinite). The Halo construction is characterised by using the Sonic ZKP which is a trustless recursive version of zkSNARKs that eliminates the need for “trusted setups” while creating proving and verifying keys. The Halo 2 construction uses the Plonk ZKP. Halo has a Structured Reference String (SRS) that can be used to build proofs with any transaction chain. Namely, in embodiments of the present disclosure it is not necessary to generate trusted setup parameters (specific keys) for every circuit.

However embodiments of the present disclosure are not limited to ZKPs of the Halo framework and can employ other types of recursive zkSNARKs. Note that a Groth16-like construction of the zkSNARK protocol is not homomorphic since it does not use polynomial commitments. Therefore, a Groth16-like construction cannot be opened in the appropriate random point and cannot be converted into recursive zkSNARK through the accumulation methods. However, it can be done in other ways through, for example, cycles of pairing friendly curves.

When utilizing the Halo construction a Structured Reference String (SRS) is generated during the setup and contains a proving/verification key-pair (pk, vk). This setup is not limited to only one single circuit, instead the SRS is universal and can be used for arbitrary circuits up to a maximum given size. Thus, the SRS can be used to build proofs with any transaction chain. Namely, it is not necessary to generate trusted setup parameters (specific keys) for every circuit. The SRS can be computed through a multiparty ceremony (which makes the system a kind of trustless system) and is linear with the size of the circuit. Hence, it depends on the size of the circuit while it is independent of the number of iterations. Namely, the proof size and verification time in embodiments of the present disclosure do not increase with the depth of recursion.

The general approach for achieving recursive proof composition is to first obtain a non-interactive argument of knowledge for arithmetic circuit satisfiability. A given circuit is satisfiable if there is a way to assign truth values (0 or 1) to the input variables such that it evaluates to 1. In other words, it is not satisfiable if every variable assignment evaluates to 0. Let C(x, w)=1 for a public x and a witness w. The verification algorithm for this argument is encoded into such an arithmetic circuit. Assuming that the verification circuit of a proof is sublinear in the size of the circuit, then by Theorem 2 described above it will be possible to recursively verify proofs such that C(x, w)=1 without disclosing any information about w. The circuit C in this construction is fixed, and the prover will repeatedly interact with the verifier to engage in multiple arguments in sequence.

Let M, Q, k be integers such that d=4M=2^{k} and 3Q<d. A system of arithmetic constraints that encodes C is satisfied for witnesses a, b, c∈ [symbol] ^{M} known only to the prover and some instance k∈ [symbol] ^{Q} which encodes the public inputs. This system of constraints consists of M multiplication constraints, where the i-th such constraint is of the form aᵢ·bᵢ=cᵢ and Q linear constraints, where the qth such constraint is of the form

$$( {\sum }_{i = 1}^{M} {a}_{i} \cdot {( {u}_{q} )}_{i} ) + ( {\sum }_{i = 1}^{M} {b}_{i} \cdot {( {v}_{q} )}_{i} ) + ( {\sum }_{i = 1}^{M} {c}_{i} \cdot {( {w}_{q} )}_{i} ) = {k}_{q}$$

for some fixed u_{q}, v_{q}, w_{q}∈ [symbol] ^{M} that encode C where i∈{1, . . . , M}, q∈{1, . . . , Q}.

In Halo, the relation treats a specific circuit in the description never changes with each recursion. The Halo construction is an incremental verifiable computation rather than proof carrying data. Note that the commitments in the Halo construction S_{old} and S_{new} are always commitments to the same polynomial S which specifies the constraints, but at different points (i.e., for old and new states). On the verifier side this is reflected in the fact that the verifier uses S_{old} in the verification equation. In order to use a variable as an input, we need to change S to be a different circuit. Namely, different transaction chain rulesets would lead to different S commitments. For a primary transaction chain, the functionality to be verified will be checking whether Txᵢ.PrevTxID==zᵢ₋₁ where zᵢ₋₁=SHA256d(Tₓ₋₁).

### Proving and Verifying an Ordered Sequence of Events

Embodiments of the present disclosure address the following problem: considering a first transaction Tx₀ (which may also contain a representation of a digital asset), and consider another transaction Txₙ that has occurred sometime after Tx₀, how can it be proved that there is a transaction chain (e.g. a primary transaction chain) linking Tx₀ to Txₙ. Known solutions require the download of the entire history of the chain of transactions originating at Tx₀ and validating each individual transaction until Txₙ.

A trivial but inefficient solution might be to utilize zkSNARKs by outsourcing to an untrusted third party to generate the proofs for each chain link (Txᵢ₋₁, Txᵢ) and provide succinct verification. However, in this solution the user has to download and verify each proof. Instead of generating a proof for each transaction, it could be possible to utilise a third party to generate a single proof for the whole transaction chain where the required computation will be of similar size.

However, in embodiments of the present disclosure a proving computing device can provide a single proof to inductively show that all previous proofs are indeed validated. In this way, the user only needs to download the first transaction Tx₀ (which may contain a digital asset) in addition to the current state of the network (i.e. the latest transaction at the end of the transaction chain) as well as a single proof that this state is correct, in order to verify the transaction chain.

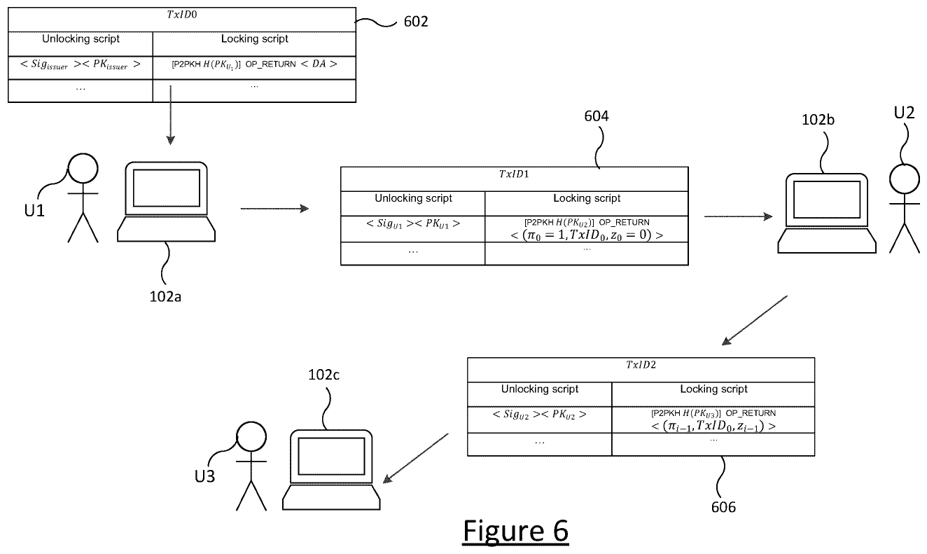

FIG. 6 illustrates transactions of a transaction chain transmitted between user computer devices 102.

FIG. 6 illustrates a transaction chain which starts with an initial transaction Tx₀ 602. We refer to this as the issuance transaction. The transaction ID TxID₀ of the issuance transaction 602 acts as a unique identifier for the transaction chain. That is, the transaction ID of the issuance transaction (i.e., TxID₀=SHA256d(Tx₀)) is an identifier which will be carried over the transaction chain.

As an initial example, FIG. 6 illustrates a use case whereby the transactions of the transaction chain represent a transfer of ownership of a digital asset. In this example, as shown in FIG. 6, the issuance transaction 602 may contain a payload which contains the digital asset (DA). The digital asset may be digital currency, an image, sound file, and/or text. In one example, the digital asset is a non-fungible token (NFT). In particular, the payload of the issuance transaction 602 may contain a unique identifier of the NFT (e.g. a serial number), an identifier of the token creator, an identifier of a storage location of the NFT and/or its most recent purchase price) etc. In some implementations, the payload of the issuance transaction 602 may contain a hash digest of the DA.

In the issuance transaction 602 shown in FIG. 6 there is a signature in the unlocking script of Tx₀ which may be from the issuer themselves, and the digital asset may be embedded after an OP_RETURN statement. As shown in FIG. 6 the first output of Tx₀ contains a P2PKH locking script with the public key of a user U₁. This assigns the ownership of the digital asset to user U₁.

As shown in FIG. 6 the issuance transaction 602 is sent to the computer equipment 102a associated with user U₁.

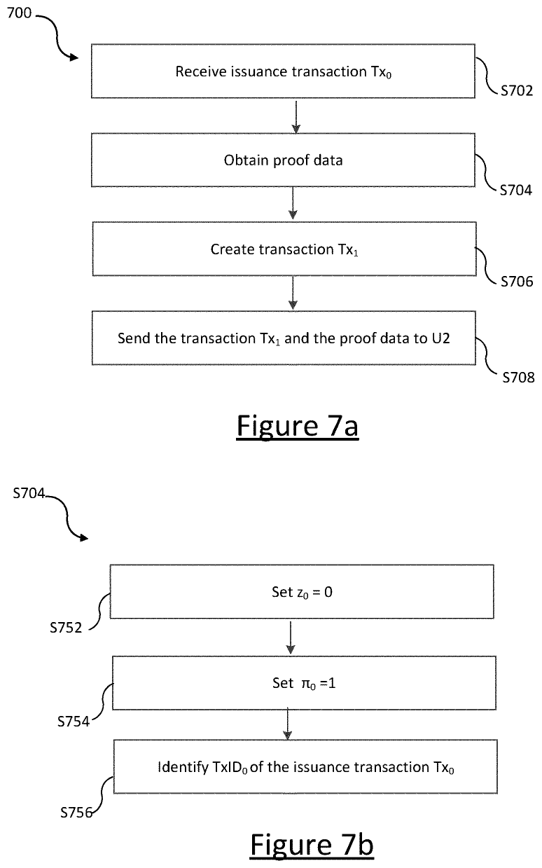

Suppose that the user U₁ would like to assign the digital asset to a user U₂, they do this by creating a new transaction Tx₁ 604. In embodiments of the present disclosure, the user U₁ performs an initialization process which is executed only once (i.e. no other user involved in the transaction chain performs the initialization process). The steps performed by the user U₁ are described in more detail below with reference to FIGS. 7a and 7b.

In the case of a primary transaction chain, the first input of transaction Tx1 604 spends the first output of the issuance transaction Tx₀ 602.

The first output of Tx1 contains a P2PKH script with the public key of a user U₂. In addition to supplying the transaction Tx1 604 to the computer equipment 102b associated with user U₂, the user U₁ also supplies proof data to the computer equipment 102b associated with user U₂. This allows for recursive proofs to be built up by following users U₂, U₃, . . . in subsequent transactions.

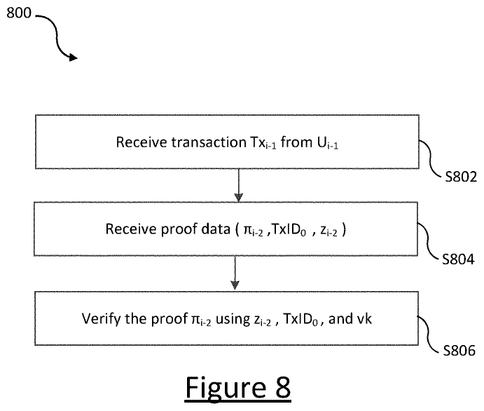

Upon receipt of the transaction Tx₁ 604 the computer equipment 102b associated with user U₂ verifies a proof provided in the proof data. The steps performed by a user U₁ upon receipt of a transaction Txᵢ₋₁ are described in more detail below with reference to FIG. 8.

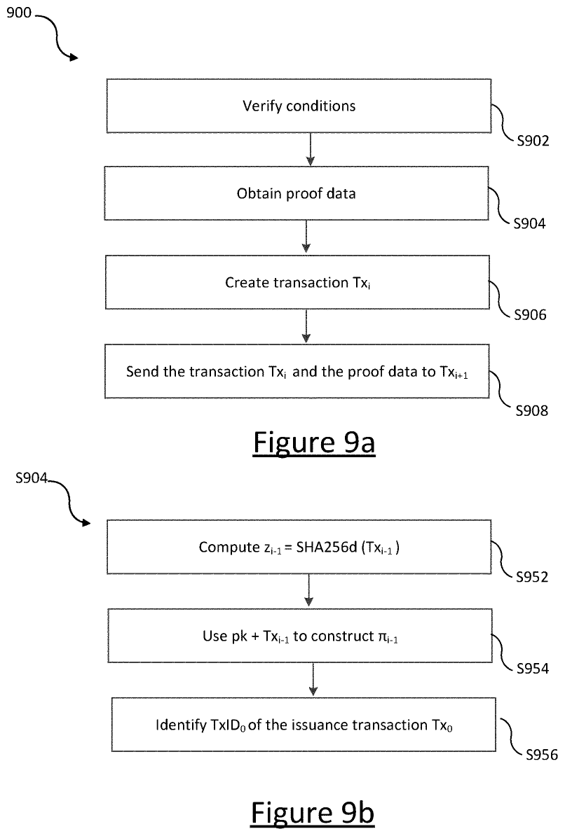

Suppose that the user U₂ would now like to transfer the digital asset to a user U₃, they do this by creating a new transaction Tx₂ 606. In embodiments of the present disclosure, the user U₂ (and any other user that is involved later on in the transaction chain) performs a recursive process. The steps performed by the user U₂ are described in more detail below with reference to FIGS. 9a and 9b.

In the case of a primary transaction chain, the first input of transaction Tx₂ 606 spends the first output of the transaction Tx₁ 604.

The first output of Tx₂ contains a P2PKH script with the public key of a user U₃. In addition to supplying the transaction Tx₂ 606 to the computer equipment 102c associated with user U₃, the user U₂ also supplies proof data to the computer equipment 102c associated with user U₃.

From the above it can be seen that each of the transactions comprise event data which relates to the transfer of ownership of the digital asset (wherein an event in this use case is the digital asset being transferred between users).

FIG. 6 illustrates embedding the digital asset (or a hash digest thereof) in the issuance transaction 602. Subsequent transactions may also comprise the digital asset (or a hash digest thereof) however this is optional. In fact, it is not necessary for any of the transactions to comprise the digital asset (or a hash digest thereof). For example, a database or other storage location on a remote device may store event data associated with each transaction in the transaction chain. For example, in the example of the digital asset being an NFT, the remote device may store the transaction ID of each transaction in the transaction chain and associate the transaction IDs with an identifier of the digital asset. In the example of the digital asset being digital currency, the remote device may store the transaction ID of each transaction in the transaction chain and associate the transaction IDs with an amount of digital currency being transferred by that transaction.

Whilst FIG. 6 illustrates the use case whereby the transactions of the transaction chain represent a transfer of ownership of a digital asset, this is merely an example.

In other embodiments, each transaction in the transaction chain may comprise event data in the form of a data record associated with a physical or digital object. For example event data in the transactions may record completion of manufacturing steps of a car (i.e. a physical object) or record revisions to an electronic file (i.e. a digital object) such as a text document, spreadsheet or other electronic file. In further embodiments, each transaction in the transaction chain may comprise event data in the form of a data record associated with a person. For example event data in the transactions may record a person's gambling activity at an online casino, or event data in the transactions may record communications between a person and their doctor. A data record associated with a transaction may be a modified version (e.g. by way of adding, removing, or changing data) of a previous data record associated with the immediately preceding transaction. Alternatively, a data record associated with a transaction may comprise entirely different data to that of a previous data record associated with the immediately preceding transaction.

In these other embodiments, the transactions in the transaction chain may comprise the event data, or in a similar manner to that described above, a database or other storage location on a remote device may store event data associated with each transaction in the transaction chain. For example, the remote device may store the transaction ID of each transaction in the transaction chain and associate the transaction IDs with a respective data record.

In FIG. 6, a user (U1, U2, U3, Un) may for example be an individual user, an organisation, or a division or department within an organisation.

In some embodiments, the transactions of the transaction chain are transmitted between the computer equipment of users involved in the transaction chain.

In some embodiments, the transactions are blockchain transactions (i.e. transactions which get committed to a blockchain 150 by way of interaction with the blockchain network 106). In these embodiments, in order for a user Uᵢ to transmit a transaction to a further user Uᵢ₊₁ the computer equipment of user Uᵢ may send the transaction to one or more blockchain nodes 104 to then be propagated throughout the network of blockchain nodes 104 and thereby included in the blockchain 150. The computer equipment of user Uᵢ₊₁ is then able to receive the transaction by reading it from the blockchain. Alternatively, the computer equipment of user Uᵢ may send the transaction to the computer equipment of the further user Uᵢ₊₁, and the computer equipment of the further user Uᵢ₊₁ may then send the transaction to one or more blockchain nodes 104 to then be propagated throughout the network of blockchain nodes 104 and thereby included in the blockchain 150.

Whilst FIG. 6 illustrates the transactions comprising proof data. This is merely an example, and the proof data could remain outside the transactions, as long as it is propagated between particular users through some communication channel.

FIG. 7a illustrates a method 700 of providing proof of an ordered sequence of events. The method 700 is performed by a computer equipment in response to receiving an initial transaction. For example with reference to FIG. 6, the method 700 is performed by the computer equipment 102a associated with user U₁.

At step S702, the computer equipment 102a receives an issuance transaction Tx₀ 602 which relates to an initial event.

The user U₁ wants to record a further event. At step S704, the computer equipment 102a obtains proof data for transmission to a further user. In embodiments of the present disclosure proof data obtained by a user Uᵢ comprises: (i) a proof value πᵢ₋₁, (ii) the transaction ID TxID₀ of the issuance transaction 602, and (iii) an identifier zᵢ₋₁ which is an identifier of the previous transaction in the transaction chain.

FIG. 7b illustrates step S704 in more detail.

At step S752, the computer equipment 102a sets the identifier z₀ to a predetermined initial value. Whilst FIG. 7b illustrates setting the identifier z₀ to zero, this is just an example and other values may be used as an indicator that the proof is a ‘null’ proof since the previous transaction is the issuance transaction Tx0 602.

At step S754, the computer equipment 102a sets the initial proof π₀ to a predetermined proof value. For example the initial proof π₀ may be set equal to 1 to assume that the proof is valid by default.

At step S756, the computer equipment 102a identifies the transaction ID TxID, of the issuance transaction 602 by reading it from the issuance transaction 602.

Referring back to FIG. 7a, once the computer equipment 102a has obtained the proof data at step S704, at step S706 the computer equipment 102a creates a new transaction Tx1 604 which comprises an output containing a P2PKH script with the public key of a user U₂.

At step S708, the computer equipment 102a sends the transaction Tx1 604 and the proof data to the computer equipment 102b associated with user U₂. The proof data will provide proof to the user U₂ that there is a transaction chain linking the transaction Tx₁ 604 to the issuance transaction 602.

As explained above, the proof data obtained at step S704 may be supplied within a field of the transaction Tx₁ 604. For example the proof data may be included in a spendable output of the transaction Tx₁ 604. Alternatively, the proof data may be included in an unspendable output of the transaction Tx₁ 604 e.g. in an OP_RETURN payload or a OP_FALSE OP_RETURN payload.

Alternatively, the proof data obtained at step S704 and the transaction Tx₁ 604 may be sent separately to the computer equipment 102b.

FIG. 8 illustrates a method 800 of verifying an ordered sequence of events. The method 800 is performed by a computer equipment in response to receiving a transaction which is not an initial transaction of a transaction chain. That is, the method 800 is performed by user U; upon receipt of a transaction Txᵢ₋₁ when i≥2.

With reference to the example of FIG. 6 described above the computer equipment 102b associated with user U₂ (and the computer equipment 102 associated with subsequent users involved in the transaction chain) performs the method 800.

At step S802, the computer equipment associated with user Uᵢ receives the transaction Txᵢ₋₁ from a further computing device associated with Uᵢ₋₁. That is, with reference to the computer equipment 102b, the computer equipment 102b associated with user U₂ receives the transaction Tx₁ 604 from the computer equipment 102a associated with user U₁.

At step S804, the computer equipment associated with user Uᵢ receives proof data. The proof data received by a user Uᵢ comprises: (i) a proof value πᵢ₋₂, (ii) the transaction ID TxID₀ of the issuance transaction 602, and (iii) an identifier zᵢ₋₂ of a previous transaction (i.e. an identifier of the transaction received by the further computing device associated with Uᵢ₋₁). Typically (for i≥3), zᵢ₋₂ corresponds to the transaction ID of the transaction in the transaction chain which is received by the computer equipment associated with user Uᵢ₋₁, however there is a unique case for user U₂ whereby the identifier z₀ is set to a predetermined initial value, as described above.

That is, with reference to the computer equipment 102b, the computer equipment 102b associated with user U₂ receives the initial proof π₀, the transaction ID TxID₀ of the issuance transaction 602, and the identifier z₀.

As explained above, the proof data may be inserted within the transaction Tx₁ 604 or transmitted externally to the transaction Tx₁ 604.

At step S806, in order to verify the proof πᵢ₋₂, the computer equipment associated with user Uᵢ supplies the proof πᵢ₋₂, the identifier zᵢ₋₂, the transaction ID TxID₀ of the issuance transaction 602, and a verification key vk_{□} as inputs into a proof verification process. The proof verification process outputs an accept or reject decision depending on whether the proof is found to be valid or invalid.

Given vk, TxID₀, Txᵢ₋₁, Txᵢ (which is created by user U; and already contains πᵢ₋₁, zᵢ₋₁), (Tx₀, . . . , Txᵢ₋₁) is accepted as a transaction chain by the new owner Uᵢ₊₁ if the proof πᵢ₋₁ is verified. If the original transaction Tx₀ contains a digital asset, then this proof will also ensure the proof of ownership for the owner of Txᵢ.

The verifier checks that the issuance transaction Tx₀ is linked to the given final transaction. Therefore, the final verification step ensures that the initial proof started with the original transaction. Also, in case of an issuance transaction with an OP_RETURN payload as shown in FIG. 6, once the proof of the transfer of the ownership is validated the receiver may accept the proof and verify the signature of the original issuer of the asset, Sigᵢₛₛᵤₑᵣ.

FIGS. 9a and 9b illustrate a method 900 of providing proof of an ordered sequence of events. The method 900 is performed by a computer equipment in response to receiving a transaction which is not an initial transaction of a transaction chain.

For example with reference to FIG. 6, the method 900 is performed by the computer equipment 102b associated with user U₂ if user U₂ wants to record a further event (e.g. if user U₂ wants to transfer a digital asset to U₃ by generating transaction Tx₂ 606) and is also performed by any subsequent users in the transaction chain who wish to record an event.

At step S902, the computer equipment 102 associated with user Uᵢ verifies that the received transaction Txᵢ₋₁ satisfies at least one predetermined condition.

That is, with reference to the computer equipment 102b, the computer equipment 102b associated with user U₂ verifies that the received transaction Tx₁ 604 satisfies at least one predetermined condition.

The at least one predetermined condition may specify that the transaction spends a transaction output of a previous transaction (the immediately preceding transaction) in the transaction chain.

Additionally or alternatively, the at least one predetermined condition may specify that the transaction comprises an index of a transaction output of the transaction. For example, the at least one predetermined condition may specify that a transaction input of the transaction comprises an index of a transaction output of the transaction (this transaction output may store the event data).

Additionally or alternatively, the at least one predetermined condition may specify that a first input of the transaction spends a first output of a previous transaction (the immediately preceding transaction) in the transaction chain i.e. the received transaction is part of a primary transaction chain. Let Tx₀, . . . , Txₙ be valid blockchain transactions with multiple input UTXOs and multiple output UTXOs. Let also (Tx₀, . . . , Txₙ) be a transaction chain. Note that the locking script of the first output of Tx₀ may also contain a digital asset. The predetermined conditions may ensure that the set of first outputs in TxSet=(Tx₀, Tx₁, . . . , Txₙ) is a primary transaction chain. Namely, for a given (0, Txₙ), the received transaction (e.g. comprising an ownership transfer) is only accepted if all transactions in TxChainSet are the first index of the transactions Tx₀, Tx₁, . . . , Txₙ.

Additionally or alternatively, the at least one predetermined condition may specify that a unique token ID (UTID) that is recorded in the received transaction.

Additionally or alternatively, the at least one predetermined condition may specify that a transaction chain sequence number i is recorded in each transaction in the chain

Additionally or alternatively, the at least one predetermined condition may specify that the received transaction records the result of a predetermined program for a given set of inputs. Some of the inputs may be the result of the computation from the previous transaction in the transaction chain, and some may be new inputs. The issuance transaction may include the predetermined code and initial set of inputs. Such a ruleset ensures that the execution of the program may be independently verified at each stage.

Each transaction may record the state of a Deterministic Finite Automata (DFA), and the at least one predetermined condition may enforce that a correct state transition has been made.

It will be appreciated that the at least one predetermined condition may comprise one or any combination of the examples referred to above.

At step S904, the computer equipment 102b obtains proof data for transmission to a further user. As explained above, in embodiments of the present disclosure proof data obtained by a user Uᵢ comprises: (i) a proof value Tᵢ₋₁, (ii) the transaction ID TxID₀ of the issuance transaction 602, and (iii) an identifier zᵢ₋₁ which is an identifier of the previous transaction in the transaction chain.

FIG. 9b illustrates step S904 in more detail.

At step S952, the computer equipment associated with user U computes the identifier zᵢ₋₁ by taking the double hash of transaction Txᵢ₋₁. That is, with reference to the computer equipment 102b, the computer equipment 102b associated with user U₂ computes the identifier z₁ by taking the double hash of the transaction Tx₁ 604.

At step S954, the computer equipment associated with user Uᵢ constructs a proof πᵢ₋₁ using a proving key pk_{□} and the transaction Txᵢ₋₁ (including the proof data associated with transaction Txᵢ₋₁ that may be within transaction Txᵢ₋₁ or transmitted separately to transaction Txᵢ₋₁). That is, with reference to the computer equipment 102b, the computer equipment 102b associated with user U₂ constructs a proof π₁ by supplying a proving key pk_{□} and the transaction Tx₁ 604 (including the proof data associated with transaction Tx₁ 604) as inputs into a proof generation process. The proof πᵢ₋₁ proves the link between transaction Txᵢ₋₂ and transaction Txᵢ₋₁.

At step S956, the computer equipment associated with user Uᵢ identifies the transaction ID TxID₀ of the issuance transaction of the transaction chain. Step S956 may be performed in a number of different ways. In one example, user Uᵢ may identify the transaction ID TxID₀ of the issuance transaction by reading it from transaction Txᵢ₋₁. That is, with reference to the computer equipment 102b, the computer equipment 102b associated with user U₂ identifies the transaction ID TxID₀ of the issuance transaction 602.

Referring back to FIG. 9a, once the computer equipment has obtained the proof data at step S904, at step S906 the computer equipment creates a new transaction Tx; which comprises an output containing a P2PKH script with the public key of a user Uᵢ₊₁. Thus, at step S906 the computer equipment 102b creates a new transaction Tx2 606 which comprises an output containing a P2PKH script with the public key of a user U₃.

At step S908, the computer equipment 102b sends the transaction Tx₂ 606 and the proof data to the computer equipment 102c associated with user U₃. The proof data will provide proof to the user U₃ that there is a transaction chain linking the transaction Tx₂ 606 to the issuance transaction 602.

As explained above, the proof data obtained at step S904 may be supplied within a field of the transaction Tx₂ 606. For example the proof data may be included in a spendable output of the transaction Tx₂ 606. Alternatively, the proof data may be included in an unspendable output of the transaction Tx₂ 606 e.g. in an OP_RETURN payload or a OP_FALSE OP_RETURN payload.

Alternatively, the proof data obtained at step S904 and the transaction Tx₂ 606 may be sent separately to the computer equipment 102c.

In embodiments of the present disclosure the proof size is approximately 3.5 kb and is independent of the number of transactions in the chain. The proof is recursive, this means that if an additional transaction is added to the transaction chain, then the proof can be updated without repeating any calculations.

The proof-carrying data is small enough to be included in an OP_RETURN statement in each transaction. This enables the solution to be an on-chain token protocol that avoids the need to trace back to issuance. In this architecture, the blockchain network 106 is used for double spend protection and to store proof-carrying data. The blockchain nodes 104 do not play a role in proof construction or verification.

### CONCLUSION

Persons skilled in the art will appreciate that the steps involved in the proof generation process implemented by a proving computer equipment will depend on the particular type of ZKP being implemented and such steps are known to persons skilled in the art. Similarly, persons skilled in the art will appreciate that the steps involved in the proof verification process implemented by a verifier computer equipment will depend on the particular type of ZKP being implemented and such steps are known to persons skilled in the art.

Other variants or use cases of the disclosed techniques may become apparent to the person skilled in the art once given the disclosure herein. The scope of the disclosure is not limited by the described embodiments but only by the accompanying claims.

Some embodiments above have been described in terms of a bitcoin network 106, bitcoin blockchain 150 and bitcoin nodes 104. However it will be appreciated that the bitcoin blockchain is one particular example of a blockchain 150 and the above description may apply generally to any blockchain. That is, the present invention is in by no way limited to the bitcoin blockchain. More generally, any reference above to bitcoin network 106, bitcoin blockchain 150 and bitcoin nodes 104 may be replaced with reference to a blockchain network 106, blockchain 150 and blockchain node 104 respectively. The blockchain, blockchain network and/or blockchain nodes may share some or all of the described properties of the bitcoin blockchain 150, bitcoin network 106 and bitcoin nodes 104 as described above.

In preferred embodiments of the invention, the blockchain network 106 is the bitcoin network and bitcoin nodes 104 perform at least all of the described functions of creating, publishing, propagating and storing blocks 151 of the blockchain 150. It is not excluded that there may be other network entities (or network elements) that only perform one or some but not all of these functions. That is, a network entity may perform the function of propagating and/or storing blocks without creating and publishing blocks (recall that these entities are not considered nodes of the preferred bitcoin network 106).

In other embodiments of the invention, the blockchain network 106 may not be the bitcoin network. In these embodiments, it is not excluded that a node may perform at least one or some but not all of the functions of creating, publishing, propagating and storing blocks 151 of the blockchain 150. For instance, on those other blockchain networks a “node” may be used to refer to a network entity that is configured to create and publish blocks 151 but not store and/or propagate those blocks 151 to other nodes.

Even more generally, any reference to the term “bitcoin node” 104 above may be replaced with the term “network entity” or “network element”, wherein such an entity/element is configured to perform some or all of the roles of creating, publishing, propagating and storing blocks. The functions of such a network entity/element may be implemented in hardware in the same way described above with reference to a blockchain node 104.

It will be appreciated that the above embodiments have been described by way of example only. More generally there may be provided a method, apparatus or program in accordance with any one or more of the following Statements.

Aspects of the present disclosure are defined below with reference to the following clauses:

1. A computer implemented method of providing proof of an ordered sequence of events, the method performed on a computing device and comprising:
receiving a transaction;
creating a further transaction to be sent to a further computing device;
obtaining proof data associated with the further transaction that provides proof to the further computing device that the further transaction is linked to an initial transaction in a transaction chain comprising the transaction, wherein the initial transaction relates to an initial event in the ordered sequence of events, and the proof data comprises: (i) a proof; (ii) an identifier of the transaction; and (iii) a unique identifier of the initial transaction; and
sending the further transaction and the proof data to the further computing device.

2. The method of clause 1, wherein the transaction is the initial transaction, and obtaining the proof data comprises: setting the proof to a predetermined proof value, and setting the identifier of the transaction to a predetermined initial value.

3. The method of clause 1, wherein the transaction is not the initial transaction of the transaction chain, the method comprises verifying that the transaction complies with at least one predetermined condition.

4. The method of clause 3, wherein the at least one predetermined condition specifies that the transaction spends a transaction output of a previous transaction in the transaction chain.

5. The method of clause 3, wherein the at least one predetermined condition specifies that the transaction comprises an index of a transaction output of the transaction.

6. The method of any of clauses 3 to 5, wherein obtaining the proof data comprises generating the proof using the transaction and a proving key; and computing the identifier of the transaction.

7. The method of any preceding clause, wherein the method comprises including the proof data in the further transaction.

8. The method of clause 7, wherein the method comprises including the proof data in a spendable output of the further transaction.

9. The method of clause 7, wherein the method comprises including the proof data in an unspendable output of the further transaction.

10. The method of any of clauses 1 to 6, wherein the proof data is not included in the further transaction and the method comprises separately sending the further transaction and the proof data to the further computing device.

11. The method of any preceding clause, wherein the transaction represents a transfer of ownership of a digital asset to a user associated with the computing device, and the further transaction represents a transfer of ownership of the digital asset to a further user associated with the further computing device.

12. The method of clause 11, wherein the digital asset is a non-fungible token.

13. The method of any of clauses 1 to 10, wherein the transaction is associated with event data, wherein the event data relates to an event in the ordered sequence of events; and wherein the further transaction is associated with further event data relating to a later event in the ordered sequence of events.

14. The method of clause 13, wherein the event data comprises a data record associated with a physical or digital object, and the further event data comprises a further data record associated with the physical or digital object.

15. The method of clause 13, wherein the event data comprises a data record associated with a user, and the further event data comprises a further data record associated with the user

16. The method of any of clauses 13 to 15, wherein the transaction comprises a representation of the event data, and the further transaction comprises a representation of the further event data.

17. The method of any of clauses 13 to 15, wherein the event data is stored on a remote device in association with the identifier of the transaction, and the method comprising storing the further event data on the remote device in association with an identifier of the further transaction.

18. The method of any preceding clause, wherein the transaction and the further transaction are blockchain transactions.

19. A computer program that, when read by a computing device, causes the computing device to perform the method of any preceding clause.

20. A non-transitory computer readable storage medium comprising computer readable instructions that, when read by a computing device, cause the computing device to perform the method of any of clauses 1 to 18.

21. A computing device comprising a processor and memory, the memory storing instructions which, when executed by the processor cause the computing device to perform the method of any of clauses 1 to 18.

22. A computer implemented method of verifying an ordered sequence of events, the method performed on a computing device and comprising:
receiving a transaction from a further computing device;
receiving, from the further computing device, proof data associated with the transaction, the proof data comprising: (i) a proof; (ii) an identifier of a previous transaction in the transaction chain; and (iii) a unique identifier of an initial transaction of the transaction chain, wherein the initial transaction relates to an initial event in the ordered sequence of events; and
verifying that the transaction is linked to the initial transaction in the transaction chain using the proof, the identifier of a previous transaction in the transaction chain, the unique identifier of the initial transaction, and a verification key.

23. The method of clause 22, wherein the transaction comprises the proof data.

24. The method of clause 23, wherein the transaction includes the proof data in a spendable output of the transaction.

25. The method of clause 23, wherein the transaction includes the proof data in an unspendable output of the transaction.

26. The method of clause 22, wherein the proof data is received separately from the transaction.

27. The method of any of clauses 22 to 26, wherein verifying that the transaction is linked to the initial transaction in the transaction chain further comprises:
obtaining the initial transaction;
computing a unique identifier of the initial transaction; and verifying that the computed unique identifier of the initial transaction matches the unique identifier of the initial transaction in the proof data.

28. The method of any of clauses 22 to 27, wherein the transaction represents a transfer of ownership of a digital asset from a user associated with the further computing device to a user associated with the computing device.

29. The method of clause 28, wherein the digital asset is a non-fungible token.

30. The method of any of clauses 22 to 27, wherein the transaction is associated with event data, wherein the event data relates to an event in the ordered sequence of events; and wherein the further transaction is associated with further event data relating to a later event in the ordered sequence of events.

31 The method of clause 30, wherein the event data comprises a data record associated with a physical or a digital object, and the further event data comprises a further data record associated with the physical or digital object.

32. The method of clause 30, wherein the event data comprises a data record associated with a user, and the further event data comprises a further data record associated with the user

33. The method of any of clauses 22 to 32, wherein the transaction is a blockchain transaction.

34. A computer program that, when read by a computing device, causes the computing device to perform the method of any of clauses 22 to 33.

35. A non-transitory computer readable storage medium comprising computer readable instructions that, when read by a computing device, cause the computing device to perform the method of any of clauses 22 to 33.

The instructions may be provided on a carrier such as a disk, CD- or DVD-ROM, programmed memory such as read-only memory (Firmware), or on a data carrier such as an optical or electrical signal carrier. The instructions to implement embodiments of the present disclosure may comprise source, object or executable code in a conventional programming language (interpreted or compiled) such as C, or assembly code, code for setting up or controlling an ASIC (Application Specific Integrated Circuit) or FPGA (Field Programmable Gate Array), or code for a hardware description language.

1. A computer implemented method of providing proof of an ordered sequence of events, the method performed on a computing device and comprising:
receiving a transaction;
creating a further transaction to be sent to a further computing device;
obtaining proof data associated with the further transaction that provides proof to the further computing device that the further transaction is linked to an initial transaction in a transaction chain comprising the transaction, wherein the initial transaction relates to an initial event in the ordered sequence of events, and the proof data comprises: (i) a proof; (ii) an identifier of the transaction; and (iii) a unique identifier of the initial transaction; and
sending the further transaction and the proof data to the further computing device.

2. The method of claim 1, wherein the transaction is the initial transaction, and obtaining the proof data comprises: setting the proof to a predetermined proof value, and setting the identifier of the transaction to a predetermined initial value.

3. The method of claim 1, wherein the transaction is not the initial transaction of the transaction chain, the method comprises verifying that the transaction complies with at least one predetermined condition.

4. The method of claim 3, wherein the at least one predetermined condition specifies that the transaction spends a transaction output of a previous transaction in the transaction chain.

5. The method of claim 3, wherein the at least one predetermined condition specifies that the transaction comprises an index of a transaction output of the transaction.

6. The method of claim 3, wherein obtaining the proof data comprises generating the proof using the transaction and a proving key; and computing the identifier of the transaction.

7. The method of claim 1, wherein the method comprises including the proof data in the further transaction.

8. The method of claim 7, wherein the method comprises including the proof data in a spendable output of the further transaction.

9. The method of claim 7, wherein the method comprises including the proof data in an unspendable output of the further transaction.

10. The method of claim 1, wherein the proof data is not included in the further transaction and the method comprises separately sending the further transaction and the proof data to the further computing device.

11. The method of claim 1, wherein the transaction represents a transfer of ownership of a digital asset to a user associated with the computing device, and the further transaction represents a transfer of ownership of the digital asset to a further user associated with the further computing device.

12. (canceled)

13. The method of claim 1, wherein the transaction is associated with event data, wherein the event data relates to an event in the ordered sequence of events; and wherein the further transaction is associated with further event data relating to a later event in the ordered sequence of events.

14. The method of claim 13, wherein the event data comprises a data record associated with a physical or digital object, and the further event data comprises a further data record associated with the physical or digital object.

15. The method of claim 13, wherein the event data comprises a data record associated with a user, and the further event data comprises a further data record associated with the user.

16. The method of claim 13, wherein the transaction comprises a representation of the event data, and the further transaction comprises a representation of the further event data.

17. The method of claim 13, wherein the event data is stored on a remote device in association with the identifier of the transaction, and the method comprising storing the further event data on the remote device in association with an identifier of the further transaction.

18. The method of claim 1, wherein the transaction and the further transaction are blockchain transactions.

19. (canceled)

20. A non-transitory computer readable storage medium comprising computer readable instructions that, when executed by a computing device, cause the computing device to perform a method of providing proof of an ordered sequence of events, the method performed on a computing device and comprising:
receiving a transaction;
creating a further transaction to be sent to a further computing device;
obtaining proof data associated with the further transaction that provides proof to the further computing device that the further transaction is linked to an initial transaction in a transaction chain comprising the transaction, wherein the initial transaction relates to an initial event in the ordered sequence of events, and the proof data comprises: (i) a proof; (ii) an identifier of the transaction; and (iii) a unique identifier of the initial transaction; and
sending the further transaction and the proof data to the further computing device.

21. (canceled)

22. A computer implemented method of verifying an ordered sequence of events, the method performed on a computing device and comprising:
receiving a transaction from a further computing device;
receiving, from the further computing device, proof data associated with the transaction, the proof data comprising: (i) a proof; (ii) an identifier of a previous transaction in the transaction chain; and (iii) a unique identifier of an initial transaction of the transaction chain, wherein the initial transaction relates to an initial event in the ordered sequence of events; and
verifying that the transaction is linked to the initial transaction in the transaction chain using the proof, the identifier of a previous transaction in the transaction chain, the unique identifier of the initial transaction, and a verification key.

23-34. (canceled)

35. A non-transitory computer readable storage medium comprising computer readable instructions that, when executed by a computing device, cause the computing device to perform a method of verifying an ordered sequence of events, the method performed on a computing device and comprising:
receiving a transaction from a further computing device;
receiving, from the further computing device, proof data associated with the transaction, the proof data comprising: (i) a proof; (ii) an identifier of a previous transaction in the transaction chain; and (iii) a unique identifier of an initial transaction of the transaction chain, wherein the initial transaction relates to an initial event in the ordered sequence of events; and
verifying that the transaction is linked to the initial transaction in the transaction chain using the proof, the identifier of a previous transaction in the transaction chain, the unique identifier of the initial transaction, and a verification key.

36. (canceled)
